(19) United States
(12) Patent Application Publication
(10) Pub. No.: US 2007/0186241 A1
(43) Pub. Date: Aug. 9, 2007

(54) Program recommendation apparatus

(75) Inventors: Noriko Sugimoto, Takarazuka-shi (JP); Soichiro Fujioka, Sakai-shi (JP); Shogo Hamasaki, Hirakata-shi (JP); Atsushi Saso, Yokohama-shi (JP); Tetsuyuki Nakayasu, Moriguchi-shi (JP); Yuko Tsusaka, Osaka-shi (JP)

Correspondence Address: WENDEROTH, LIND & PONACK, L.L.P., 2033 K STREET N. W., SUITE 800, WASHINGTON, DC, 20006-1021, US

(73) Assignee: MATSUSHITA ELECTRIC INDUSTRIAL CO., LTD., Osaka (JP)

(21) Appl. No.: 10/566,674

(22) PCT Filed: Jul. 30, 2004
(86) PCT No.: PCT/JP04/11283

§ 371 Date: Jul. 31, 2006

(30) Foreign Application Priority Data
Aug. 6, 2003 (JP) 2003-287563

(51) Int. Cl. H04N 5/445; G06F 3/00; G06F 13/00; H04N 7/025; H04N 7/10; H04N 7/173

(52) U.S. Cl. 725/46; 725/34; 725/35; 725/109

(57) ABSTRACT

A program recording/playback apparatus for easily recording/playing back a program that matches a common preference between multiple viewers is provided. A recording/playback apparatus 100 obtains program recommendation information from a server apparatus 300, and retrieves program recommendation information from within. Based on these two pieces of program recommendation information, the recording/playback apparatus 100 generates and combines two search formulas, to generate one search formula. The recording/playback apparatus 100 then identifies one or more programs that satisfy the conditions shown by the one search formula, within EPG data extracted from received broadcast waves, thereby generating program presetting information. The recording/playback apparatus 100 generates a recorded program table based on the generated program presetting information, and displays the recorded program table. The recording/playback apparatus 100 then receives a user's selection indicating one or more of the programs shown by the recorded program table, and reads and plays back the selected programs.

### TECHNICAL FIELD

The present invention relates to a technique to extract and recommend a program matching a preference of a viewer.

### BACKGROUND ART

As the number of channels for broadcasting has recently increased, the number of broadcast programs has increased. Furthermore, having a storage medium with a larger capacity for storing programs, reception apparatuses can store increasingly more programs of many hours. Therefore, by recording programs, program viewers can select a program to watch from a far greater number of programs than before.

Here, there has been a challenge of how to select, record and play back programs that match a preference of a particular viewer, from a large number of programs.

To deal with this challenge, a program recommendation apparatus has been proposed, which can recommend programs that match a preference of a user, according to the user's program selections.

Such a program recommendation apparatus determines a recommended program in the following manner. The program recommendation apparatus interprets electronic program guide (EPG) data, which is broadcast together with television program contents. The program recommendation apparatus generates a plurality of pieces of profile information each of which indicates a particular category and indicates a program preference of a viewer. The program recommendation apparatus determines a program to be recommended, based on the generated plurality of pieces of profile information. Thus, for example, the viewer can cause the program recommendation apparatus to record programs that are selected according to his/her preferences which are meticulously defined by categories such as dramas and sports.

Here, there are cases where a plurality of viewers, for example, family members and friends, gather and enjoy watching a program together, and the number of such cases is thought to rise. Therefore, there is a demand for a technique to easily select a program matching a common preference between all of the viewers.

### DISCLOSURE OF THE INVENTION

In response to the above demand, an objective of the present invention is to provide a program recommendation apparatus, a program recommendation method, and a computer program to recommend programs, which facilitate selection of a program which matches a common preference between a plurality of viewers.

This objective is achieved by a program recommendation apparatus for generating a program guide that includes recommended program information. The program recommendation apparatus includes a program information obtaining unit operable to obtain a plurality of pieces of program information each relating to a program to be broadcast, a first obtaining unit operable to obtain first recommendation information relating to a recommended program, a second obtaining unit operable to obtain second recommendation information relating to a different recommended program, a recommendation information generating unit operable to generate, for a user, user recommendation information relating to a program recommended to the user, based on the obtained first recommendation information and second recommendation information, a program guide generating unit operable to extract one or more pieces of recommended program information each relating to a program recommended to the user, from the obtained plurality of pieces of program information, with reference to the generated user recommendation information, and generate a program guide including the extracted pieces of recommended program information in association with the user, and an output unit operable to output the generated program guide to be displayed.

According to this construction, the user recommendation information can be generated based on the first recommendation information and second recommendation information, and the program guide including the recommended program information matching a common preference between the plurality of viewers can be generated based on the generated user recommendation information.

Here, the program guide generating unit may align the extracted pieces of recommended program information in an order determined according to a priority assigned to the user, and generate the program guide including the aligned extracted pieces of recommended program information.

According to this construction, the program guide includes a plurality of pieces of program identification information aligned in accordance with the priorities of the users. This makes it easy for the users to select a program.

Here, the program recommendation apparatus further includes a screen generating unit operable to form a plurality of user display areas respectively having sizes determined according to priorities assigned to a plurality of users including the user, and generate a priority screen including the formed plurality of user display areas, and a screen output unit operable to output the generated priority screen to be displayed.

According to this construction, the priorities assigned to the plurality of users can be easily recognized visually.

Here, the screen generating unit may generate the priority screen which is circular, form the plurality of user display areas which are respectively sectors, and arrange the sectoral user display areas around a central point of the circular priority screen.

According to this construction, the priorities assigned to the users are displayed using sectors. Therefore, the priorities can be easily recognized visually.

Here, the screen generating unit may form the plurality of user display areas which are rectangular, and arrange the rectangular user display areas within the priority screen.

According to this construction, the priorities assigned to the users are displayed using rectangles. Therefore, the priorities can be easily recognized visually.

Here, the screen generating unit may further cause a plurality of pieces of priority information respectively indicating the priorities assigned to the plurality of users, to be displayed in the plurality of user display areas.

According to this construction, the precise values of the priorities assigned to the users can be recognized.

Here, the screen generating unit may further obtain genre information indicating a program genre corresponding to the user recommendation information, and cause the obtained genre information to be displayed within a corresponding one of the plurality of user display areas.

According to this construction, the users can easily know a program genre corresponding to user recommendation information.

Here, the screen generating unit may further obtain a representative image of the program recommended by the user recommendation information, and cause the obtained representative image to be displayed within a corresponding one of the plurality of user display areas.

According to this construction, the users can visually obtain the contents of a program corresponding to user recommendation information.

Here, the program recommendation apparatus may further include a receiving unit operable to receive an increase or decrease in the sizes of the plurality of user display areas included in the priority screen, and a modifying unit operable to modify the priorities assigned to the plurality of users, based on the sizes of the plurality of user display areas which have been changed according to the received increase or decrease.

According to this construction, the priorities assigned to the users can be easily modified visually.

Here, the program guide generating unit may align the extracted pieces of recommended program information in a chronological order, and generate the program guide including the chronologically aligned extracted pieces of recommended program information.

According to this construction, the program guide includes the plurality of pieces of recommended program information aligned in a chronological order. This makes it easy for the users to select a program.

Here, the program information obtaining unit obtains the plurality of pieces of program information, by receiving a broadcast wave carrying the plurality of pieces of program information and extracting the plurality of pieces of program information from the received broadcast wave.

According to this construction, the program information is extracted from the broadcast wave. Therefore, the program information can be easily and reliably obtained without requiring human labor force.

Here, the program information obtaining unit may obtain the plurality of pieces of program information each of which at least includes a summary of the program, a scheduled broadcast time of the program, a duration of the program, and a broadcast channel of the program, and the program guide generating unit may extract the pieces of recommended program information, with reference to the summary of the program included in each of the plurality of pieces of program information.

According to this construction, the program guide generating unit refers to the summary of the program. Therefore, program information satisfying the recommendation condition can be reliably extracted.

Here, the first obtaining unit may obtain the first recommendation information from a different apparatus, and the second obtaining unit may include a recommendation information storing unit prestoring the second recommendation information, and a recommendation information reading unit operable to read the second recommendation information from the recommendation information storing unit.

According to this construction, the first recommendation information is obtained from a different apparatus, and the second recommendation information is obtained from within the program recommendation apparatus. Thus, various types of recommendation information can be obtained.

Here, the program recommendation apparatus may be connected to the different apparatus via a network, and the first obtaining unit may obtain the first recommendation information from the different apparatus via the network.

According to this construction, the first recommendation information is obtained from the different apparatus connected to the program recommendation apparatus via the network. Therefore, the first recommendation information can be easily and reliably obtained without requiring human labor force.

Here, the first obtaining unit may obtain the first recommendation information including a first condition to select the recommended program, the second obtaining unit may obtain the second recommendation information including a second condition to select the different recommended program, and the recommendation information generating unit may extract the first condition and second condition respectively from the first recommendation information and second recommendation information, combine the extracted first condition and the second condition using a logical operation, to generate a recommendation condition, and generate the user recommendation information including the generated recommendation condition.

According to this construction, the first and second conditions are combined using a logical operation. In this way, a recommendation condition indicating a preference that satisfies the plurality of users can be generated.

Here, the first obtaining unit may obtain the first recommendation information including first keyword information as the first condition, the second obtaining unit may obtain the second recommendation information including second keyword information as the second condition, the recommendation information generating unit may extract the first keyword information and second keyword information respectively from the first recommendation information and second recommendation information, and combine, using a logical operation, the extracted first keyword information and second keyword information, to generate the recommendation condition, and the program guide generating unit may extract the pieces of recommended program information satisfying the recommendation condition included in the user recommendation information.

According to this construction, the extracted recommended program information satisfies the recommendation condition generated by, using a logical operation, combining the first keyword information and second keyword information respectively extracted from the first recommendation information and second recommendation information. In this way, recommended program information matching a preference that satisfies the plurality of users can be reliably extracted.

Here, the first obtaining unit may obtain the first recommendation information including a first search formula generated by combining a plurality of keywords using a logical operation, as the first condition, the second obtaining unit may obtain the second recommendation information including a second search formula generated by combining a plurality of keywords using a logical operation, as the second condition, the recommendation information generating unit may extract the first search formula and second search formula respectively from the first recommendation information and second recommendation information, and combine, using a logical operation, the extracted first search formula and second search formula, to generate the recommendation condition, and the program guide generating unit may extract the pieces of recommended program information satisfying the recommendation condition included in the user recommendation information.

According to this construction, the extracted recommended program information satisfies the recommendation condition generated by, using a logical operation, combining the first search formula and second search formula respectively extracted from the first recommendation information and second recommendation information. In this way, recommended program information matching a preference that satisfies the plurality of users can be reliably extracted.

Here, the recommendation information generating unit may receive a designation of a logical operation from the user, and combine the first condition and second condition using the received logical operation.

According to this construction, the users can freely designate the type of the logical operation.

Here, the first obtaining unit may obtain the first recommendation information including viewing permission information indicating whether the user has viewing permission, the recommendation information generating unit may generate the user recommendation information including the viewing permission information, and the program guide generating unit may extract the viewing permission information from the user recommendation information, and when the extracted viewing permission information indicates that the user has viewing permission, extract the pieces of recommended program information.

According to this construction, recommended program information satisfying the recommendation condition is extracted when the viewing permission information extracted from the user recommendation information indicates that viewing is permitted. In this way, viewing of programs can be limited.

Here, the first obtaining unit may obtain the first recommendation information including generator identification information indicating a generator who has generated the first recommendation information.

According to this construction, the first recommendation information includes the generator identification information indicating the generator who has generated the first recommendation information. Therefore, the users can know the person who has generated the first recommendation information.

Here, the program recommendation apparatus may further include a recommendation information generation unit operable to generate output recommendation information, based on the user recommendation information generated by the recommendation information generating unit, and an external output unit operable to output the generated output recommendation information to an external apparatus.

According to this construction, the output recommendation information indicating a program matching a preference that satisfies the plurality of users can be generated based on the generated user recommendation information, and the generated output recommendation information can be utilized at an external apparatus.

Here, the program recommendation apparatus may be connected to the external apparatus via a network, and the external output unit may output the output recommendation information to the external apparatus via the network.

According to this construction, the generated output recommendation information can be utilized at a different apparatus connected to the program recommendation apparatus via a network.

Here, the program recommendation apparatus may be a reception/recording apparatus for receiving and recording a broadcast. The program recommendation apparatus may further include a receiving unit operable to receive a broadcast program content, an information storing unit, a judging unit operable to judge whether the received program content is to be recorded, with reference to the user recommendation information generated by the recommendation information generating unit, and a writing unit operable to write, when the judging unit judges that the program content is to be recorded, the program content into the information storing unit.

According to this construction, the generated user recommendation information is utilized to judge whether the received program content should be recorded or not. In this way, a program content matching a preference that satisfies a plurality of viewers can be recorded.

Here, the program guide output by the output unit may be displayed by a display apparatus, and the program recommendation apparatus may further include a reception unit operable to receive a selection of one of programs included in the program guide displayed by the display apparatus, a reading unit operable to read a program content corresponding to the selected program, from the information storing unit, a signal generating unit operable to generate an audio-visual signal from the read program content, and a signal output unit operable to output the generated audio-visual signal to the display apparatus.

According to this construction, a program content corresponding to a program selected from the programs included in the displayed program guide can be read from the information storing unit, and output. In this way, a group of viewers can watch a program content matching a preference that satisfies them.

As described above, profile information which can be selected by a user in a conventional program recommendation apparatus is suitable in the case of a single viewer, but poses the following problems in the case of a group of viewers such as family members and friends. Firstly, profile information needs to be newly generated for each group, and this is a time-consuming process. Secondly, favorable profile information can not be generated for a group of viewers when each of the viewers has a very different preference in terms of program.

The present invention can solve these problems. In detail, the present invention can easily generate profile information for a group of viewers who record or watch a program together, thereby satisfying a variety of needs of viewers who record or watch a program together.

### BRIEF DESCRIPTION OF THE DRAWINGS

FIG. 1 illustrates an overall construction of a program recommendation system 1 relating to an embodiment of the present invention.

FIG. 2 is a block diagram illustrating a construction of a server apparatus 300.

FIG. 3 is a block diagram illustrating a construction of a recording/playback apparatus 100.

FIG. 4 is a block diagram illustrating a construction of a program presetting information generation unit 116.

FIG. 5 is an external view illustrating a remote controller 200.

FIG. 6 is an exploded view illustrating the remote controller 200.

FIG. 7 is an external perspective view illustrating a positional relationship between a transmissive photointerrupter 248 and an operation knob 231.

FIG. 8 is a cross-sectional view illustrating the remote controller 200 along a line AA.

FIG. 9 illustrates a positional relationship between the operation knob 221, a spring 261, and a spring 262.

FIG. 10 illustrates, as an example, a data structure of EPG data.

FIG. 11 illustrates, as an example, a data structure of program recommendation information 420.

FIG. 12 illustrates, as an example, a data structure of program recommendation information 430.

FIG. 13 illustrates, as an example, a data structure of a search formula A generated by an interpretation unit 131.

FIG. 14 illustrates, as an example, a data structure of a search formula B generated by an interpretation unit 133.

FIG. 15 illustrates, as an example, a data structure of a program presetting information group 450.

FIG. 16 illustrates, as an example, a data structure of a record presetting information group 460.

FIG. 17 illustrates, as an example, a data structure of a playback presetting information group 470.

FIG. 18 illustrates, as an example, a menu screen displayed by a monitor 119.

FIG. 19 illustrates, as an example, a selection screen displayed by the monitor 119, which is used by a user to select a different user's program recommendation information.

FIG. 20 illustrates, as an example, a selection screen displayed by the monitor 119, which is used by the user to select the user's own program recommendation information.

FIG. 21 illustrates, as an example, a program guide displayed by the monitor 119.

FIG. 22 illustrates, as an example, a recorded program table displayed by the monitor 119.

FIG. 23 illustrates a relationship among program sets extracted based on a plurality of pieces of program recommendation information corresponding to a plurality of viewers.

FIG. 24 includes flow charts illustrating operations of an antenna 101 and a tuner unit 102, an extraction unit 103, and a recording unit 105.

FIG. 25 is a flow chart illustrating an operation of a record presetting control unit 107.

FIG. 26 is a flow chart mainly illustrating an operation of a control unit 111.

FIG. 27 is a flowchart illustrating an operation of obtaining a different user's program recommendation information, which is performed by a program recommendation information input unit 121 and the server apparatus 300.

FIG. 28 is a flowchart illustrating an operation of selecting a user's own program recommendation information, which is performed by a program recommendation information input unit 124.

FIG. 29 is a flow chart illustrating an operation of a search information generation unit 122.

FIG. 30 is a flow chart illustrating an operation performed by the interpretation units 131 and 133 to generate the search formulas A and B.

FIG. 31 illustrates, as another example, a selection screen displayed by the monitor 119, which is used by the user to select the user's own program recommendation information.

FIG. 32 illustrates, as an example, a data structure of each type of information stored in a personal information storage unit 135 in a recording/playback apparatus relating to a modification example, and continues in FIG. 33.

FIG. 33 continues from FIG. 32, and illustrates, as an example, the data structure of each type of information stored in the personal information storage unit 135 in the recording/playback apparatus relating to the modification example.

FIG. 34 illustrates a construction of a priority input screen 601 generated by a GUI generation unit 117.

FIG. 35 illustrates a change in a priority input screen, particularly a change in position of each bar.

FIG. 36 illustrates a change in a priority input screen, particularly a change in each icon.

FIG. 37 illustrates how eight buttons 281 to 288 are arranged around the operation knob 231 of a remote controller 200b.

FIG. 38 illustrates a construction of a priority input screen 621 generated by the GUI generation unit 117.

FIG. 39 illustrates a construction of a priority input screen 631 generated by the GUI generation unit 117.

FIG. 40 illustrates a construction of a recorded program screen 701 generated by the GUI generation unit 117.

FIG. 41 illustrates a construction of a recorded program screen 711 generated by the GUI generation unit 117.

FIG. 42 illustrates a construction of a recorded program screen 721 generated by the GUI generation unit 117.

FIG. 43 illustrates a construction of a recorded program screen 731 generated by the GUI generation unit 117.

### BEST MODE FOR CARRYING OUT THE INVENTION

### 1. FIRST EMBODIMENT

The following describes a program recommendation system 1 relating to an embodiment of the present invention.

1.1 Construction of Program Recommendation System 1

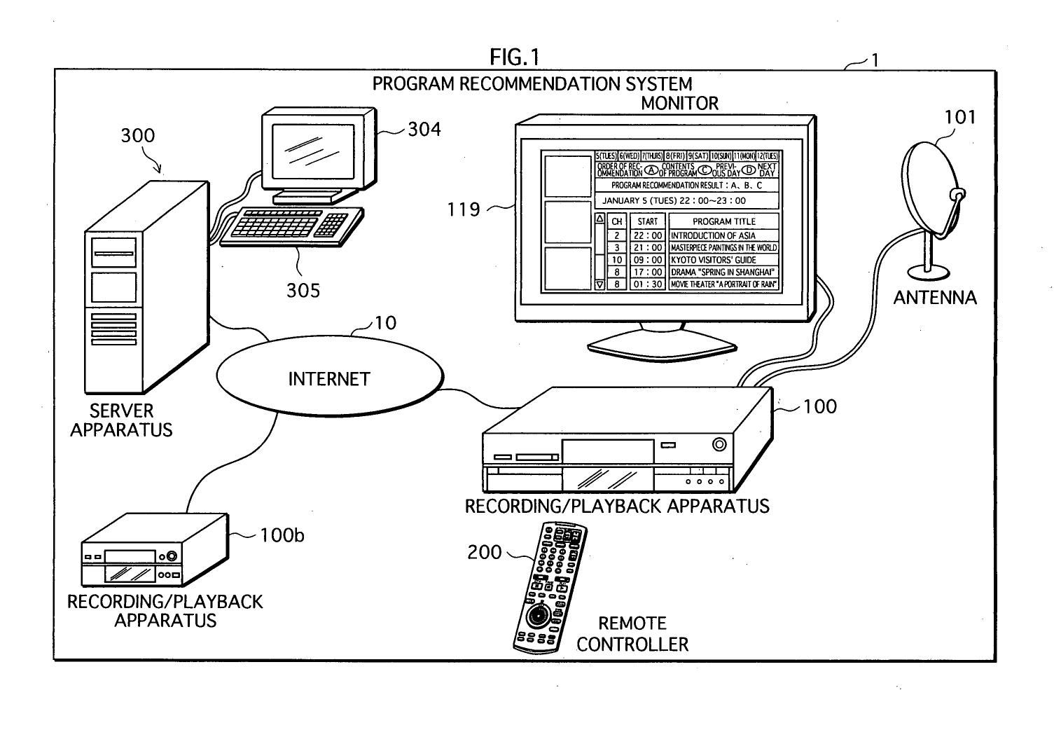

As shown in FIG. 1, the program recommendation system 1 is constituted by a broadcasting apparatus (not shown in FIG. 1), a broadcasting antenna (not shown in FIG. 1), a recording/playback apparatus 100, an antenna 101, a monitor 119, a remote controller 200, a recording/playback apparatus 100b, and a server apparatus 300. The recording/playback apparatus 100, recording/playback apparatus 100b, and server apparatus 300 are connected to each other via the Internet 10.

The broadcasting apparatus broadcasts programs and EPG data on broadcast waves, via the broadcasting antenna. Here, a program is audio-visual information including images and sounds.

EPG data is transmitted from a broadcast station, together with audio-visual information, in various kinds of digital broadcasting. EPG data includes information about each program, such as a broadcast channel, starting date and time, a summary, and a cast list.

The recording/playback apparatus 100 obtains program recommendation information from the server apparatus 300, and designates program recommendation information stored therein, in response to a user's instruction. Based on these two pieces of program recommendation information, the recording/playback apparatus 100 generates and combines two search formulas, to generate a single search formula.

It should be noted that, according to the present invention, program recommendation information indicates a user's preference regarding programs. Program recommendation information is generated with respect to each viewer, each group of viewers, each interest of a viewer, and each purpose of viewing.

Subsequently, the recording/playback apparatus 100 receives the broadcast waves via the antenna 101, extracts the programs and EPG data separately from the received broadcast waves, and stores the extracted EPG data therein. Following this, the recording/playback apparatus 100 generates presetting program information based on the EPG data stored therein. Here, presetting program information indicates a program satisfying a condition shown by the generated search formula. The recording/playback apparatus 100 then receives the program indicated by the generated presetting program information, and stores the program therein.

Furthermore, the recording/playback apparatus 100 generates a recorded program table based on the generated presetting program information, and causes the generated recorded program table to be displayed. Thus, the recording/playback apparatus 100 receives a selection of any of the programs shown in the recorded program table through the user's instruction, and reads and plays back the selected program.

The recording/playback apparatus 100b has the same construction as the recording/playback apparatus 100.

1.2 Construction of Server Apparatus 300

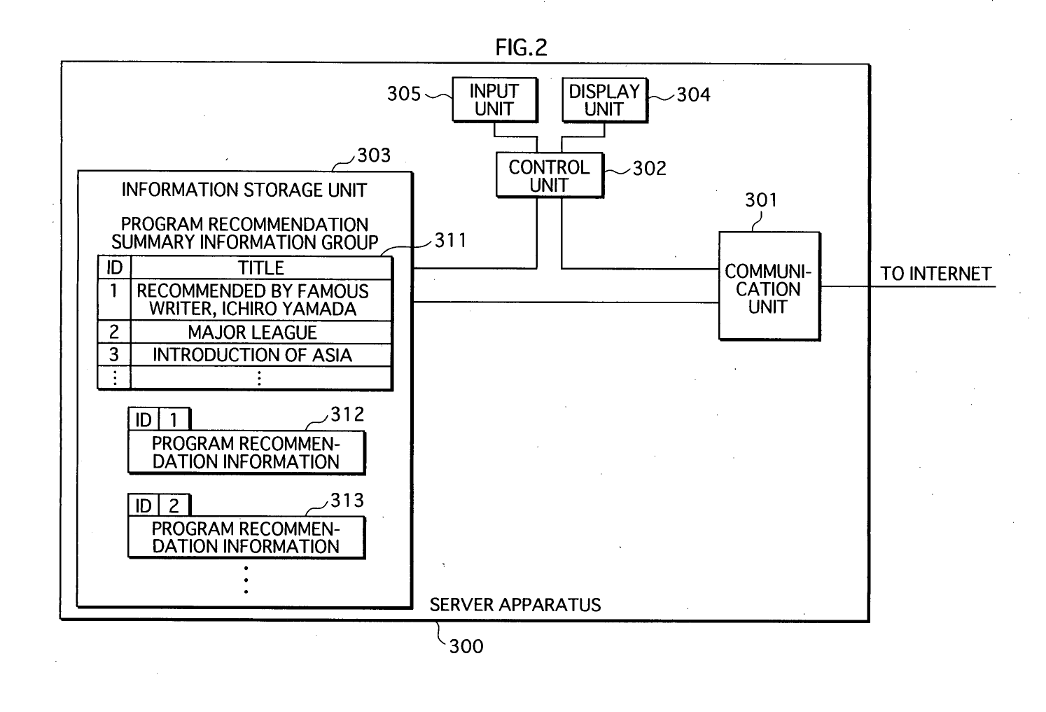

The server apparatus 300 is constituted by a communication unit 301, a control unit 302, an information storage unit 303, a display unit 304, and an input unit 305, as shown in FIG. 2.

The server apparatus 300 is specifically a computer system including a microprocessor, a ROM, a RAM, a hard disc unit, a communication unit, a display unit, a keyboard, and a mouse. The RAM or hard disc unit stores a computer program thereon. The microprocessor operates in accordance with the computer program, which realizes functions of each constituent of the server apparatus 300.

(1) Communication Unit 301

The communication unit 301 is connected to the recording/playback apparatus 100 via the Internet 10, so that the recording/playback apparatus 100 transmits/receives information to/from the control unit 302.

(2) Information Storage Unit 303

The information storage unit 303 prestores a program recommendation summary information group 311, program recommendation information 312, program recommendation information 313, . . . .

The program recommendation information 312, program recommendation information 313, . . . are each assigned with an ID that is identification information to identify the corresponding program recommendation information.

Each piece of program recommendation information is text information written in the Extensible Markup Language (XML), and includes a presetting information area, a keyword area, and a search formula area.

The presetting information area includes program presetting information indicating a program to be recorded or played back. The program presetting information includes date information, starting time information, ending time information, and broadcast channel information. The date information indicates a date on which the program is broadcast, the starting time information indicates a time, in hours and minutes, at which the broadcasting of the program starts, the ending time information indicates a time, in hours and minutes, at which the broadcasting of the program ends, and the broadcast channel information indicates a channel in which the program is broadcast.

The keyword area includes one or more pieces of keyword information. Each piece of keyword information includes a keyword which is a character string. The keyword is used as a search condition when particular program information is searched for and extracted from the EPG data. When the keyword area includes a plurality of pieces of keyword information, particular program information is searched for within the EPG data, based on a result of a logical AND operation between the keywords included in the plurality of pieces of keyword information.

The search formula area includes one or more pieces of search formula information. Each piece of search formula information includes a search formula. The search formula includes a plurality of keywords, and a logical AND or OR symbol to combine the keywords together. The search formula is used as a search condition to search for and extract particular broadcast program information from the EPG data. When the search formula area includes a plurality of pieces of search formula information, particular broadcast program information is searched for within the EPG data, based on a result of a logical OR operation between the search formulas included in the plurality of pieces of search formula information.

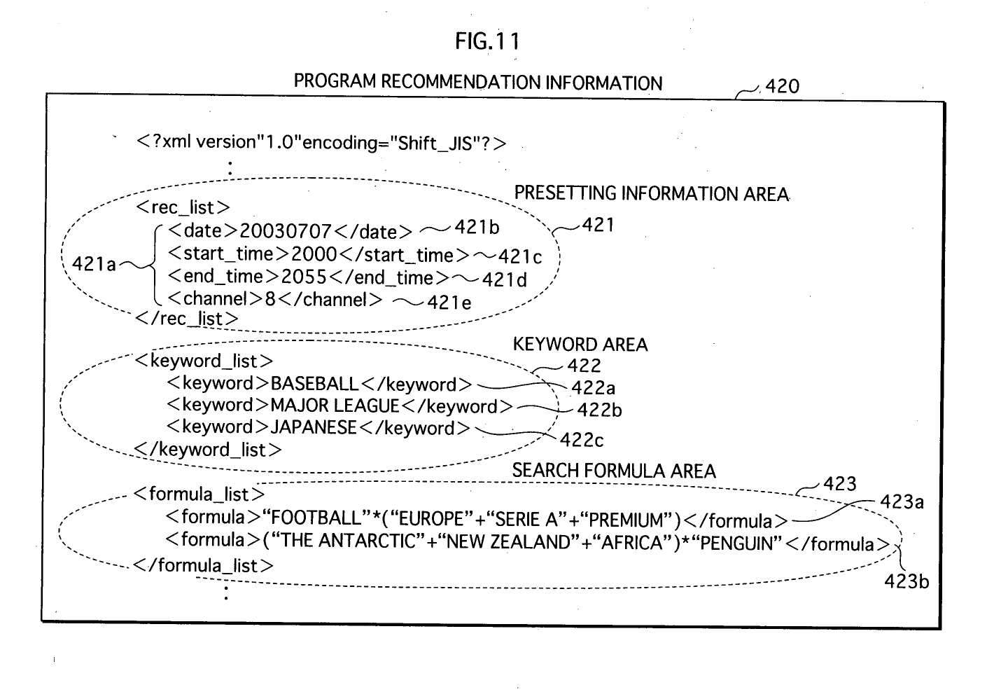

As a specific example of the program recommendation information 312, program recommendation information 313, . . . , FIG. 11 shows program recommendation information 420. As shown in FIG. 11, the program recommendation information 420 is text information written in XML. The program recommendation information 420 includes a presetting information area 421, a keyword area 422, and a search formula area 423.

The presetting information area 421 includes program presetting information 421a indicating a program to be recorded or played back. The program presetting information 421a includes date information 421b, starting time information 421c, ending time information 421d, and broadcast channel information 421e. The date information 421b indicates “Jul. 7, 2003”, the starting time information 421c indicates “20:00”, the ending time information 421d indicates “20:55”, and the broadcast channel information 421e indicates “channel 8”. In other words, the presetting information area 421 has therein program presetting information indicating a program to be broadcast from 20:00 to 20:55 on Jul. 7, 2003, on the channel 8. When using the program presetting information 421ain the presetting information area 421, the recording/playback apparatus 100 records the program indicated by the program presetting information 421a, and plays back the recorded program.

The keyword area 422 includes multiple pieces of keyword information 422a to 422c. The pieces of keyword information 422a to 422c respectively include keywords “BASEBALL”, “MAJOR LEAGUE”, and “JAPANESE”. Since the keyword area 422 has a plurality of pieces of keyword information, program information search is conducted within the EPG data based on the result of the logical AND operation between the plurality of keywords {“BASEBALL”*“MAJOR LEAGUE”*“JAPANESE”}.

Furthermore, the search formula area 423 has multiple pieces of search formula information 423a and 423b.

The search formula information 423a includes a keyword “FOOTBALL”, a logical AND operation symbol “*”, a bracket “(”, a keyword “EUROPE”, a logical OR operation symbol “+”, a keyword “SERIE A”, a logical OR operation symbol “+”, a keyword “PREMIUM”, and a bracket “)”. Which is to say, the search formula included in the search formula information 423a indicates a condition where “FOOTBALL” is included, and (logical AND operation) any of “EUROPE”, “SERIE A”, and “PREMIUM” is included (logical OR operation).

The search formula information 423b includes a bracket “(”, a keyword “THE ANTARCTIC”, a logical OR operation symbol “+”, a keyword “NEW ZEALAND”, a logical OR operation symbol “+”, a keyword “AFRICA”, a bracket “)”, a logical AND operation symbol “*”, and a keyword “PENGUIN”. Which is to say, the search formula included in the search formula information 423b indicates a condition where any of “THE ANTARCTIC”, “NEW ZEALAND”, and “AFRICA” is included (logical OR operation), and (logical AND operation) “PENGUIN” is included.

As described above, the search formula area 423 has two pieces of search formula information. Therefore, when the pieces of search formula information in the search formula area 423 are used for a program information search, broadcast program information which satisfies a result of a logical OR operation between the two pieces of search formula information 423a and 423b is extracted from the EPG data. The program indicated by the extracted broadcast program information is recorded, and the recorded program is played back.

Turning back to FIG. 2, the program recommendation summary information group 311 is constituted by a plurality of pieces of program recommendation summary information. Each piece of program recommendation summary information corresponds to program recommendation information, and includes an ID and a title. Here, the ID is identification information to identify the program recommendation information as mentioned above, and the title is a name identifying the program recommendation information.

As mentioned above, program recommendation information is text information written in XML. Because of this data structure, a viewer can, for example, modify program recommendation information, and add a comment and the like, using an editor or the like, if necessary.

(3) Control Unit 302

The control unit 302 receives a request for a program recommendation summary information group, from the recording/playback apparatus 100, via the Internet 10 and communication unit 301. When receiving the request for the program recommendation summary information group, the control unit 302 reads the program recommendation summary information group from the information storage unit 303. The control unit 302 then extracts an ID and a title from each piece of program recommendation summary information included in the read program recommendation summary information group. Based on the extracted IDs and titles, the control unit 302 generates selection screen information to form a selection screen. Here, the selection screen information is written in Hyper Text Markup Language (HTML).

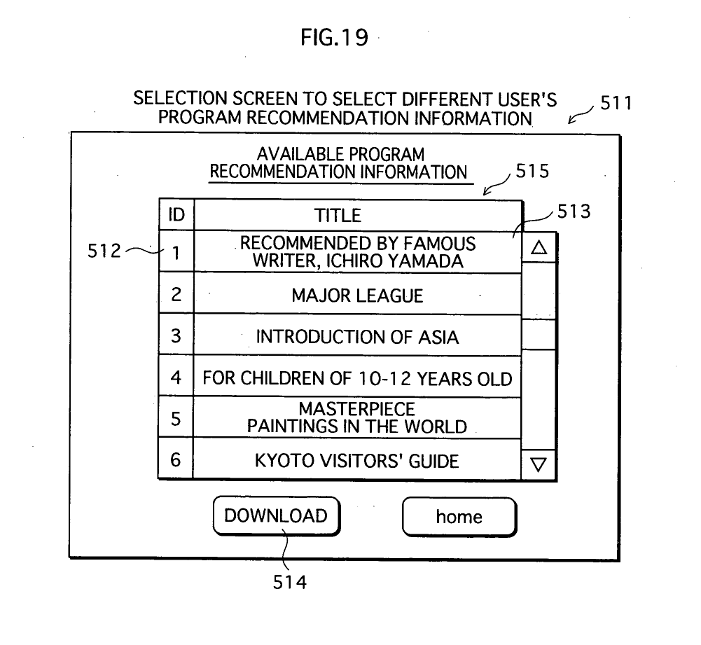

Here, FIG. 19 shows an example of such a selection screen, which includes a title of the screen “AVAILABLE PROGRAM RECOMMENDATION INFORMATION”, a list display part 515, a button 514 showing “DOWNLOAD”, and other screen elements. The list display part 515 includes a plurality of display rows each of which has an ID and a title. The button 514 is an operation button, which indicates that program recommendation information corresponding to an ID selected by the user is transferred from the server apparatus 300 to the recording/playback apparatus 100.

The control unit 302 transmits the generated selection screen information to the recording/playback apparatus 100, via the communication unit 301 and Internet 10.

Furthermore, the control unit 302 receives an ID indicating particular program recommendation information, from the recording/playback apparatus 100, via the Internet 10 and communication unit 301. When receiving the ID, the control unit 302 reads program recommendation information assigned with the received ID, from the information storage unit 303. The control unit 302 then transmits the read program recommendation information to the recording/playback apparatus 100, via the communication unit 301 and Internet 10.

(4) Input Unit 305 and Display Unit 304

The input unit 305 receives an instruction from an operator of the server apparatus 300, and outputs the received instruction to the control unit 302.

The display unit 304 displays a variety of information, in accordance with a control performed by the control unit 302.

1.3 Construction of Recording/Playback Apparatus 100

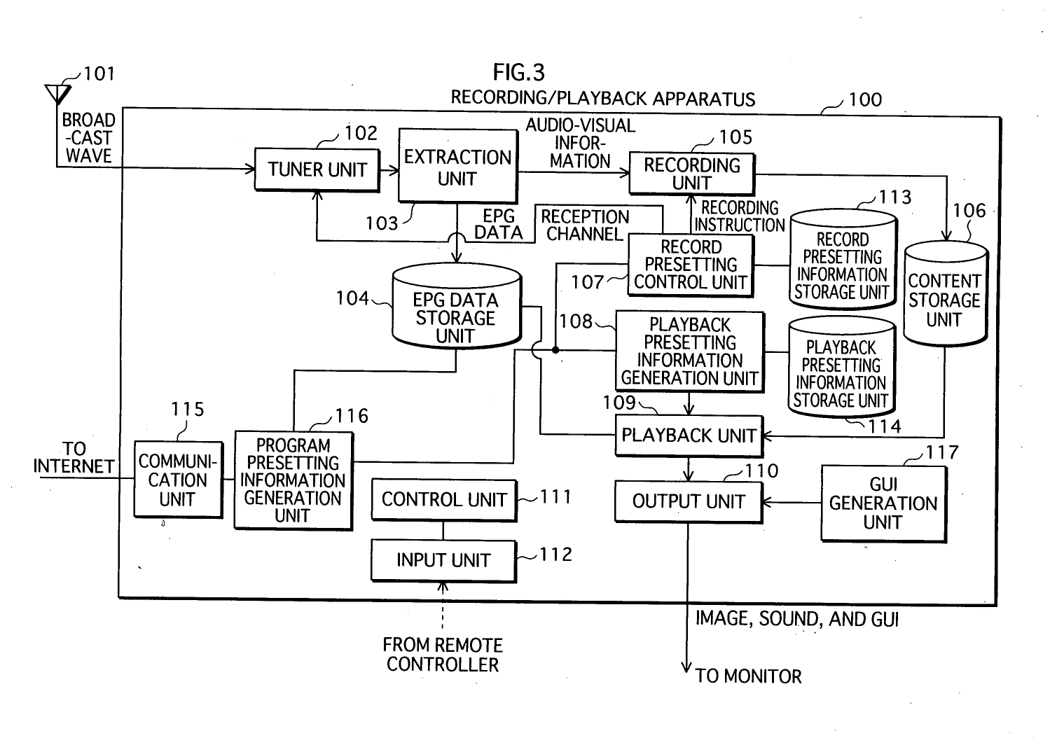

As shown in FIG. 3, the recording/playback apparatus 100 is constituted by a tuner unit 102, an extraction unit 103, an EPG data storage unit 104, a recording unit 105, a content storage unit 106, a record presetting control unit 107, a playback presetting information generation unit 108, a playback unit 109, an output unit 110, a control unit 111, an input unit 112, a record presetting information storage unit 113, a playback presetting information storage unit 114, a communication unit 115, a program presetting information generation unit 116, and a GUI generation unit 117. The tuner unit 102 is connected to the antenna 101. The communication unit 115 is connected to the Internet 10. Here, the recording/playback apparatus 100 receives an infrared ray emitted by the remote controller 200, and operates in accordance with the received infrared ray. The recording/playback apparatus 100 is connected to the monitor 119, which is a display device with a loudspeaker.

A viewer can watch images and listen to sounds of a program, through the monitor 119 connected to the output unit 110.

The recording/playback apparatus 100 is specifically a computer system including a microprocessor, a ROM, a RAM, and a hard disc unit. The RAM or hard disc unit stores thereon a computer program. The microprocessor operates in accordance with the computer program, which realizes some of functions of the recording/playback apparatus 100.

It is assumed that this recording/playback apparatus 100 is used when a single user or group of users records and watches a program. Hereinafter, such users are referred to as viewers.

The EPG data storage unit 104, content storage unit 106, record presetting information storage unit 113, and playback presetting information storage unit 114 can be realized by using a known storage device such as a hard disc unit and a semiconductor memory. According to FIG. 3, the EPG data storage unit 104, content storage unit 106, record presetting information storage unit 113, and playback presetting information storage unit 114 are separate units, but may be included in a single storage medium.

(1) Remote Controller 200

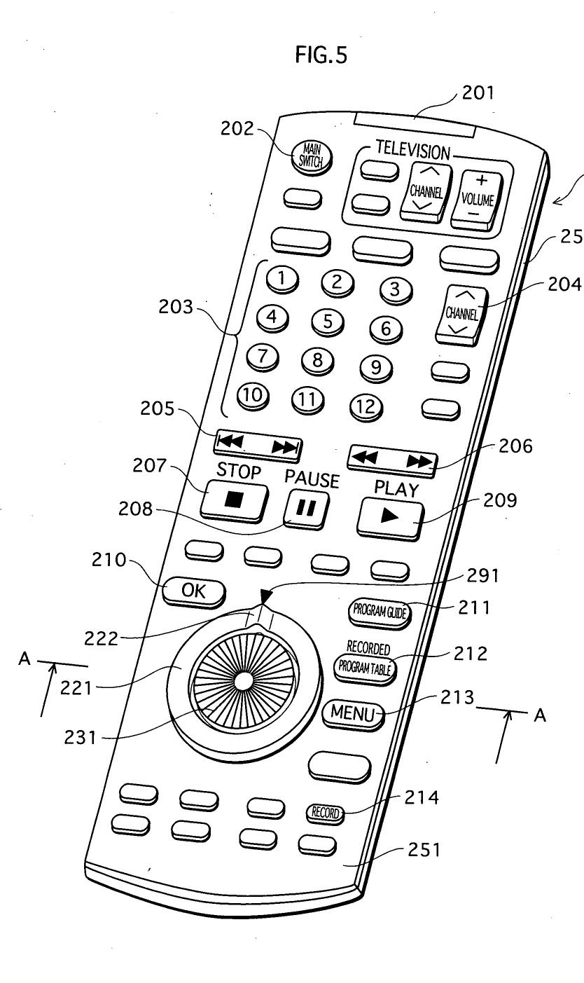

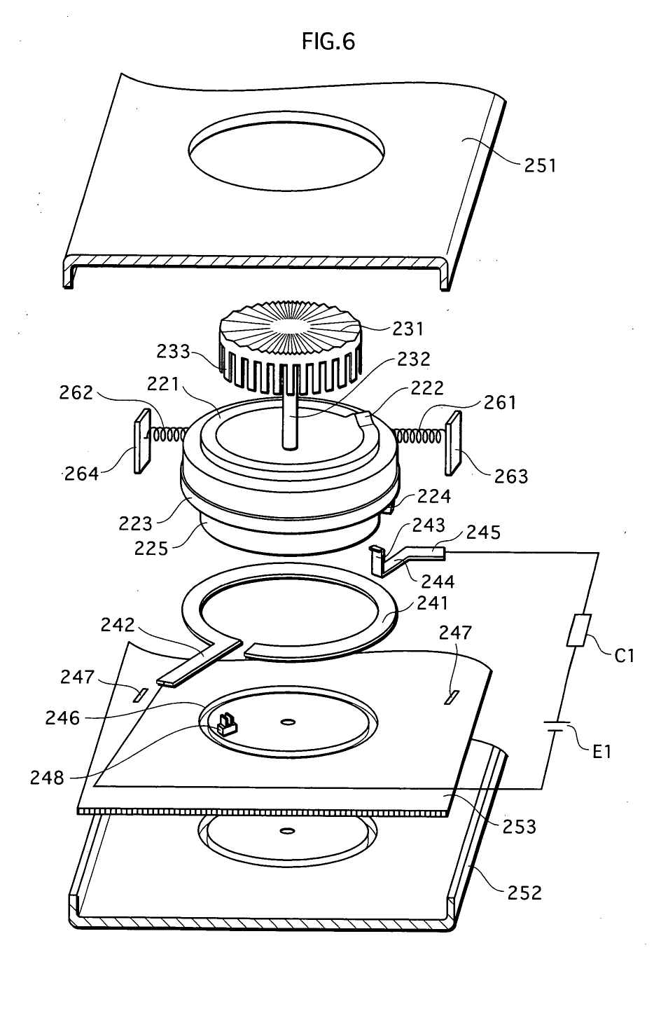

As shown in FIGS. 5 and 6, the remote controller 200 has a casing formed by an upper case 251, and a lower case 252. In the casing, a wiring board 253 formed like a flat plate is held by the lower case 252.

In a front surface of the upper case 251, a plurality of through-holes are provided. Through these through-holes, an operation button 202, a button group 203, buttons 204 to 214, a ring-like operation knob 221, a cylindrical operation knob 231, and an infrared ray emission unit 201 are partly exposed.

A surface of the button 202 is written with “MAIN SWITCH”, surfaces of buttons constituting the button group 203 are respectively written with numbers from “1” to “12”, and surfaces of the buttons 211 to 213 are respectively written with “PROGRAM GUIDE”, “RECORDED PROGRAM TABLE”, and “MENU”.

By operating the button 202, the user can turn the recording/playback apparatus 100 on or off. By operating any of the buttons written with the numbers “1” to “12”, the user can select a channel corresponding to the operated button.

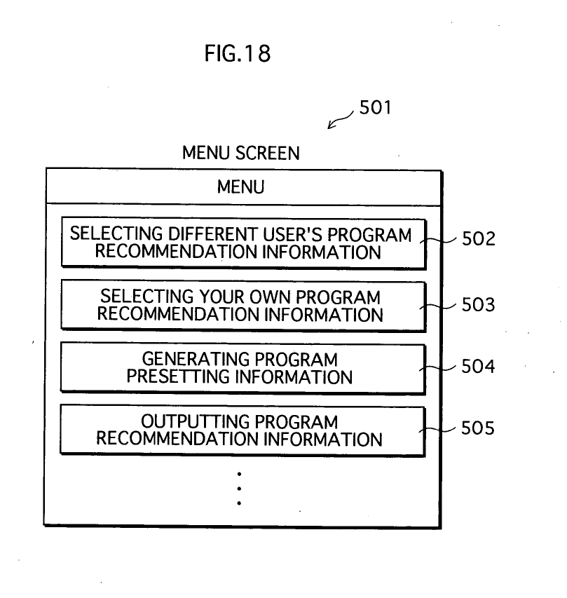

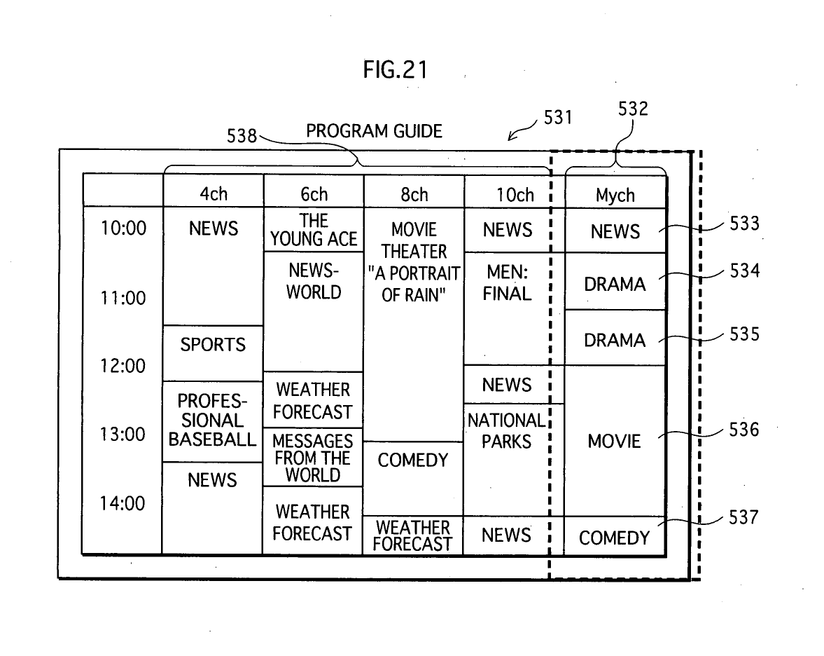

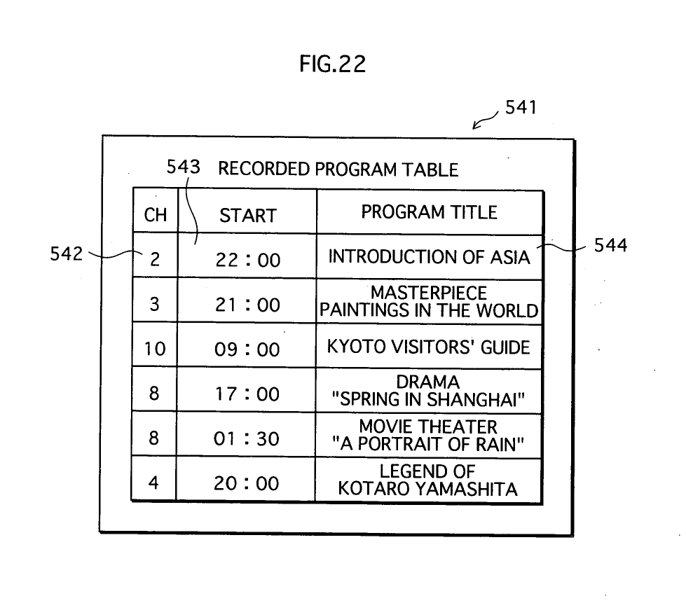

By operating the buttons 211 to 213 written with “PROGRAM GUIDE”, “RECORDED PROGRAM TABLE”, and “MENU” respectively, the user can cause the recording/playback apparatus 100 to generate a program guide 531 shown in FIG. 21, a recorded program table 541 shown in FIG. 22, and a menu screen 501 shown in FIG. 18. The recording/playback apparatus 100 then causes the monitor 119 to display the generated program guide 531, recorded program table 541, and menu screen 501.

On the wiring board 253, switches are provided in positions that face the operation button 202, buttons constituting the button group 203, and buttons 204 to 214. The switches open and close in accordance with the user's button operation. Also, the infrared ray emission unit 201 and a conversion circuit (not shown in FIGS. 5 and 6) are provided on the wiring board 253.

When the switches open and close according to the user's operation of the operation button 202, buttons constituting the button group 203, and buttons 204 to 214, the conversion circuit detects that the switches open and close. The conversion circuit generates an electrical signal corresponding to the detected result, converts the generated electrical signal into a digital signal, and outputs the generated digital signal to the infrared ray emission unit 201. The infrared ray emission unit 201 receives the digital signal, and emits or stops emitting an infrared ray in accordance with the received digital signal.

In the manner described above, the remote controller 200 emits an infrared ray carrying a signal corresponding to a button operated by the user.

Here, as shown in FIGS. 5 and 6, the operation knob 231 has a rod-like supporting member 232 extending along a central axis of the cylindrical operation knob 231. The supporting member 232 goes through the wiring board 253, and is kept so as to be capable of rotating around the axis of the cylindrical operation knob 231. Here, one end of the supporting member 232 is in contact with the lower case 252. Furthermore, the operation knob 231 has a plurality of comb-tooth parts, which are configured like teeth of a comb so as to form an external surface of a cylinder. By a rotation operation performed by the user, the cylindrical operation knob 231 rotates around its axis. The rotation of the operation knob 231 causes the comb-tooth parts to rotate around the axis of the cylindrical operation knob 231.

Here, an upper circular surface of the operation knob 231 which is exposed through a through hole in the upper case 251 is made uneven to prevent slipping when the user operates the operation knob 231 with his/her fingers.

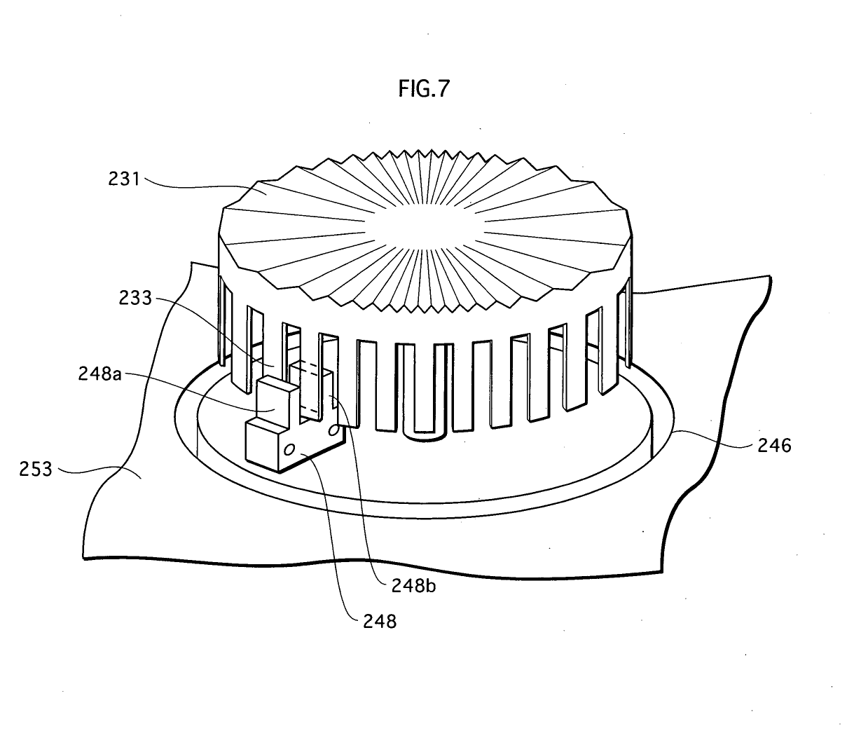

As shown in FIG. 7, a transmissive photointerrupter 248 includes (i) an emission element 248a for emitting light, and (ii) a reception element 248b. The emission element 248a and reception element 248b are provided so as to face each other. The emission element 248a emits light, and the reception element 248b receives the light emitted by the emission element 248a, generates an electrical signal in accordance with an amount of the received light, and outputs the electrical signal. As shown in FIG. 7, the photointerrupter 248 is arranged on the wiring board 253 so that the comb-tooth parts of the operation knob 231 pass between the emission element 248a and reception element 248b, when the comb-tooth parts rotate. The rotation of the comb-tooth parts switches between a state where light emitted by the emission element 248a is blocked, and a state where light reaches the reception element 248b without being blocked.

In the photointerrupter 248, the reception element 248b generates and outputs an electrical signal to the conversion circuit. The conversion circuit receives the electrical signal, converts the received electrical signal into the digital signal, and outputs the generated digital signal to the infrared ray emission unit 201. The infrared ray emission unit 201 receives the digital signal, and emits or stops emitting an infrared ray in accordance with the received digital signal.

In the manner described above, the remote controller 200 emits an infrared ray carrying a signal in accordance with an amount of the rotation of the operation knob 231 performed by the user.

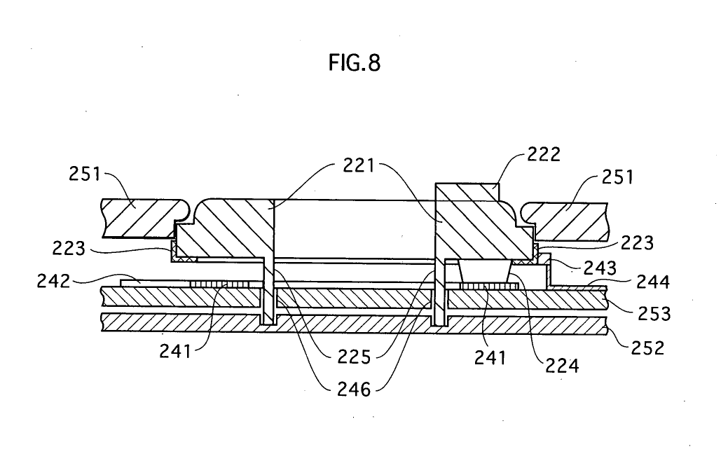

The operation knob 221 has a protrusion 222 on its ring-like surface which is exposed through a through-hole in the upper case 251, and a tubular supporting member 225 erecting from a bottom surface of the tubular operation knob 221, as shown in FIGS. 5, 6 and 8. The supporting member 225 runs through the wiring board 253, and is kept in contact with the lower case 252 so as to be capable of rotating around its axis.

In the casing, a ring-like conductive member 223 is provided so as to run along the external surface of the tubular operation knob 221. Furthermore, a conductive connection terminal 224 is provided on the bottom surface of the tubular operation knob 221 so as to face toward the lower case 252. The connection terminal 224 is connected to the conductive member 223, and arranged so as to be in contact with a resistor 241 (mentioned later).

The resistor 241 is formed like a ring with a portion being removed. The resistor 241 is provided on the wiring board 253 so that the central axis of the resistor 241 coincides with the central axis of the tubular operation knob 221. An end of the resistor 241 is connected to a conductive member 242.

Furthermore, a conductive connection terminal 243 is provided on the wiring board 253 so as to be in contact with the conductive member 223.

The connection terminal 243 and a conductive member 247 are supplied with a direct-current constant voltage, by a power source E1. The resistor 241, a current measurement circuit C1, and the power source E1 are connected in series together, to form a closed circuit. The current measurement circuit C1 measures a current flowing in this closed circuit. The power source E1 and current measurement circuit C1 are provided on the wiring board 253.

When the user operates the operation knob 221 by rotating, the connection terminal 224 rotates around the axis of the operation knob 221, with being in contact with the resistor 241. This rotation causes a change in distance from the conductive member 242 to the contact point between the resistor 241 and connection terminal 224. Hence, in accordance with the rotation, the current measured by the current measurement circuit C1 changes. Accordingly, the measured current determines an angle of the rotation performed by the user's operation of the operation knob 221.

The current measurement circuit C1 generates an electrical signal in accordance with the measured current, and output the generated electrical signal to the conversion circuit. The conversion circuit receives the electrical signal, converts the received electrical signal into a digital signal, and outputs the generated digital signal to the infrared ray emission unit 201. The infrared ray emission unit 201 receives the digital signal, and emits or stops emitting an infrared ray in accordance with the received digital signal.

In the manner described above, the remote controller 200 emits an infrared ray carrying a signal determined in accordance with an angle of the rotation of the operation knob 221 performed by the user.

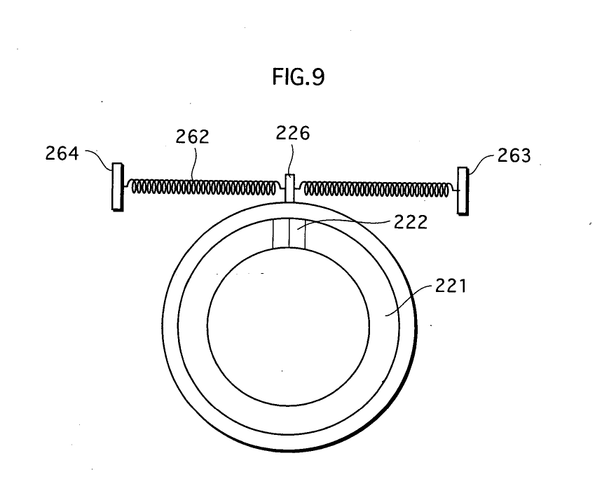

As shown in FIG. 9, the operation knob 221 has a supporting part 226 on its external surface, in the upper case 251. The supporting part 226 is connected to one end of a coil-like spring 261. The other end of the spring 261 is connected to a supporting part 263 provided on the wiring board 253. Thus, the supporting part 226 is pushed toward the supporting part 263 by the spring 261. Also, the supporting part 226 is connected to one end of a coil-like spring 262. The other end of the spring 262 is connected to a supporting part 264 provided on the wiring board 253. Thus, the supporting part 226 is pushed toward the supporting part 264 by the spring 262.

(2) Input Unit 112

The input unit 112 receives an infrared ray emitted by the remote controller 200, reads a signal carried by the received infrared ray, and outputs the read signal to the control unit 111.

Furthermore, the input unit 112 has a plurality of buttons. When the user operates any of the buttons, the input unit 112 generates a signal corresponding to the operated button, and outputs the generated signal to the control unit 111.

(3) Antenna 101 and Tuner Unit 102

The antenna 101 receives the broadcast waves broadcast by the broadcasting apparatus owned by a broadcaster or the like, and outputs the received broadcast waves to the tuner unit 102.

The tuner unit 102 receives a reception channel from the user's operation through the remote controller 200, input unit 112 and control unit 111, or from the record presetting control unit 107. The tuner unit 102 then selects broadcast data that is transmitted via the received reception channel, from the broadcast waves, and outputs the selected broadcast data to the extraction unit 103.

The tuner unit 102 may be configured so as to be capable of receiving, all together, visual information, audio information, and EPG data broadcast via TV-Asahi Data and Multimedia Service (ADAMS), Communication Satellite (CS), Broadcasting Satellite (BS), terrestrial digital broadcasting or the like.

(4) Extraction Unit 103

The extraction unit 103 receives the broadcast data from the tuner unit 102, and extracts audio-visual information and EPG data separately from the received broadcast data. The extraction unit 103 then outputs the extracted audio-visual information to the recording unit 105, and writes the extracted EPG data into the EPG data storage unit 104.

(5) EPG Data Storage Unit 104

The EPG data storage unit 104 has an area to store EPG data.

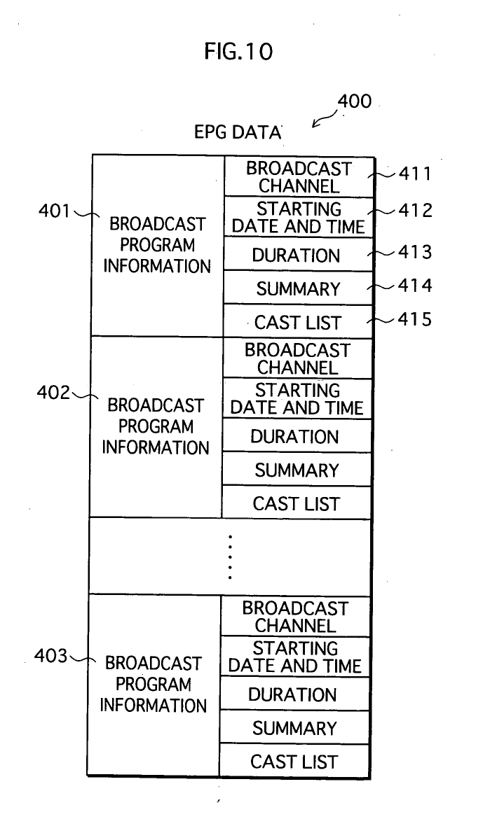

FIG. 10 shows an example of EPG data. EPG data 400 shown in FIG. 10 is constituted by broadcast program information 401, broadcast program information 402, . . . and broadcast program information 403.

Each piece of broadcast program information corresponds to a broadcast program, and includes a broadcast channel, starting date and time, a duration, a summary, and a cast list.

The broadcast channel indicates a channel through which the program is broadcast, the starting date and time indicates a date (year, month, and day) and a time (hours and minutes) at which the program is broadcast, the duration indicates a time period from a broadcast starting time to a broadcast ending time of the program, the summary is a brief description of the program, and the cast list indicates a name of a person present in the program.

(6) Recording Unit 105

The recording unit 105 receives the audio-visual information from the extraction unit 103.

Also, the recording unit 105 receives a recording instruction from the user's operation, via the remote controller 200, input unit 112, and control unit 111, or from the record presetting control unit 107. When receiving the recording instruction, the recording unit 105 writes the audio-visual information received from the extraction unit 103 into the content storage unit 106.

Furthermore, the recording unit 105 receives a recording end instruction from the user's operation, via the remote controller 200, input unit 112, and control unit 111, or from the record presetting control unit 107. When receiving the recording end instruction, the recording unit 105 stops writing the audio-visual information received from the extraction unit 103 into the content storage unit 106.

(7) Content Storage Unit 106

The content storage unit 106 has an area to store audio-visual information.

(8) Program Presetting Information Generation Unit 116

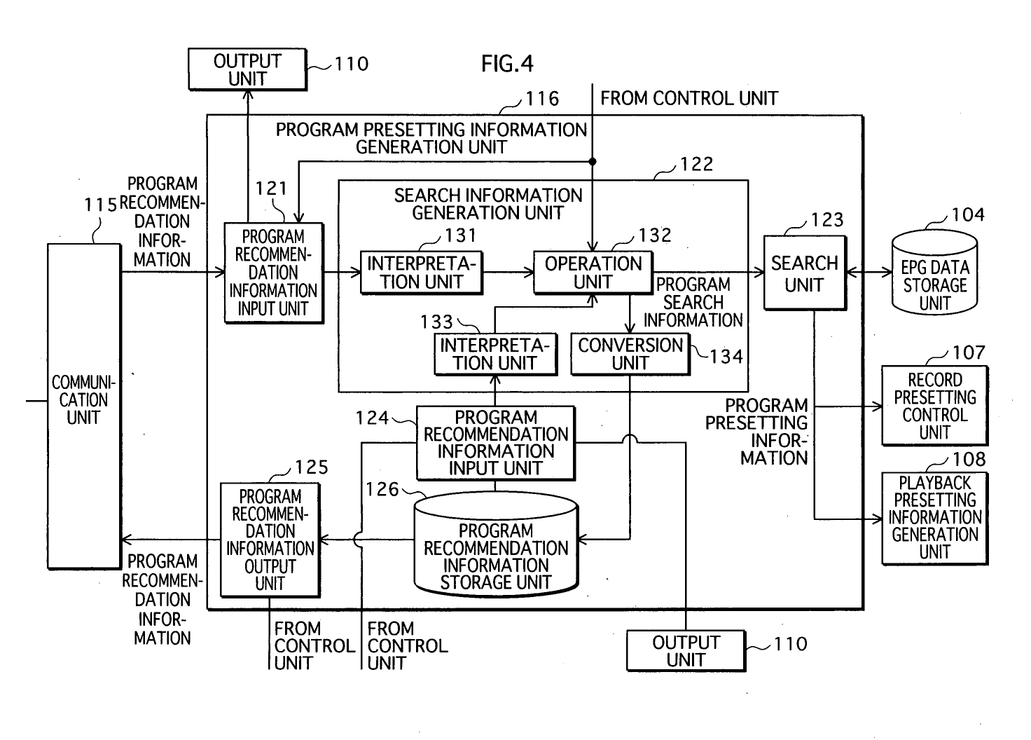

The program presetting information generation unit 116 is constituted by a program recommendation information input unit 121, a search information generation unit 122, a search unit 123, a program recommendation information input unit 124, a program recommendation information output unit 125, and a program recommendation information storage unit 126, as shown in FIG. 4.

The program presetting information generation unit 116 generates program presetting information, based on program recommendation information obtained by the program recommendation information input unit 121 from an external source, and program recommendation information stored in the program recommendation information storage unit 126, by using the EPG data stored in the EPG data storage unit 104, in the manner described later.

(a) Program Recommendation Information Input Unit 121

The program recommendation information input unit 121 receives, from the control unit 111, an instruction of obtaining a different user's program recommendation information from an external apparatus. Here, such an external apparatus is the server apparatus 300, for example.

When receiving this instruction, the program recommendation information input unit 121 transmits a request for a program recommendation summary information group, to the server apparatus 300 via the communication unit 115 and Internet 10.

Subsequently, the program recommendation information input unit 121 receives selection screen information from the server apparatus 300 via the Internet 10 and communication unit 115, and outputs the received selection screen information to the output unit 110.

After this, the program recommendation information input unit 121 receives an ID from the input unit 112 via the control unit 111, and transmits the received ID to the server apparatus 300 via the communication unit 115 and Internet 10.

Following this, the program recommendation information input unit 121 receives program recommendation information identified by the ID, from the server apparatus 300, via the Internet 10 and communication unit 115, and outputs the received program recommendation information to the search information generation unit 122.

FIG. 11 shows an example of the program recommendation information received from the server apparatus 300.

Here, program recommendation information may be prestored in a storage medium, and the program recommendation information input unit 121 may read program recommendation information from such a storage medium.

(b) Program Recommendation Information Storage Unit 126

The program-recommendation information storage unit 126 stores one or more pieces of program recommendation information. In addition, the program recommendation information storage unit 126 stores titles indicating the pieces of program recommendation information in a one-to-one correspondence.

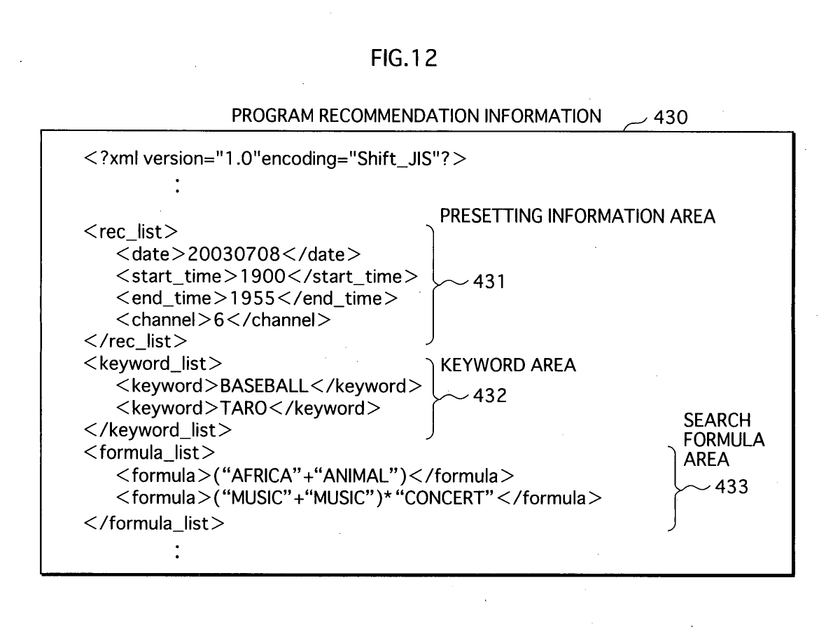

FIG. 12 shows program recommendation information stored in the program recommendation information storage unit 126, as an example.

Program recommendation information 430 shown in FIG. 12 has the same data structure as the program recommendation information 420 shown in FIG. 11.

The program recommendation information 430 shown in FIG. 12 includes a presetting information area 431, a keyword area 432, and a search formula area 433.

The presetting information area 431 specifically has program presetting information indicating a program to be broadcast from 19:00 to 19:55 on Jul. 8, 2003, on the channel 6.

The keyword area 432 specifically has keywords “BASEBALL” and “TARO”. Here, “TARO” is a common Japanese name.

The search formula area 433 specifically has search formula information including a search formula indicating a result of a logical OR operation between the keywords “AFRICA” and “ANIMAL”, and search formula information including a search formula indicating a result of a logical AND operation between (i) a result of a logical OR operation between the keywords “MUSIC” and “MUSIC”, and (ii) a keyword “CONCERT”.

(c) Program Recommendation Information Input Unit 124

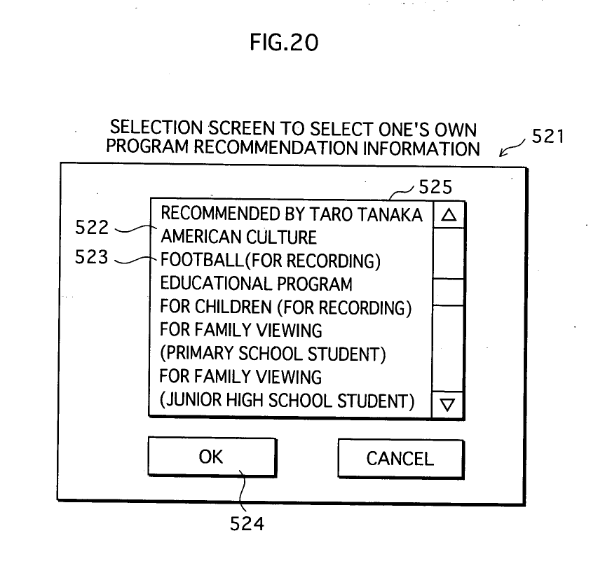

The program recommendation information input unit 124 reads the titles indicating the pieces of program recommendation information from the program recommendation information storage unit 126. Subsequently, the program recommendation information input unit 124 generates a selection screen 521 (shown in FIG. 20), and outputs the generated selection screen 521 to the output unit 110. Here, the selection screen 521 is formed by a display part 525 displaying a list of the read titles, a button 524, and other buttons and display parts. In this way, the selection screen 521 is displayed by the monitor 119.

After this, the program recommendation information input unit 124 receives a designation of program recommendation information, from the remote controller 200 via the input unit 112 and control unit 111. The program recommendation information input unit 124 then reads the designated program recommendation information from the program recommendation information storage unit 126, and outputs the read program recommendation information to the search information generation unit 122.

(d) Search Information Generation Unit 122

The search information generation unit 122 includes an interpretation unit 131, an operation unit 132, an interpretation unit 133, and a conversion unit 134, as shown in FIG. 4.

(i) Interpretation Unit 131

The interpretation unit 131 receives program recommendation information from the program recommendation information input unit 121.

When receiving the program recommendation information, the interpretation unit 131 generates a search formula A based on the received program recommendation information in the following manner, and outputs the generated search formula A to the operation unit 132.

(Generation of Search Formula A)

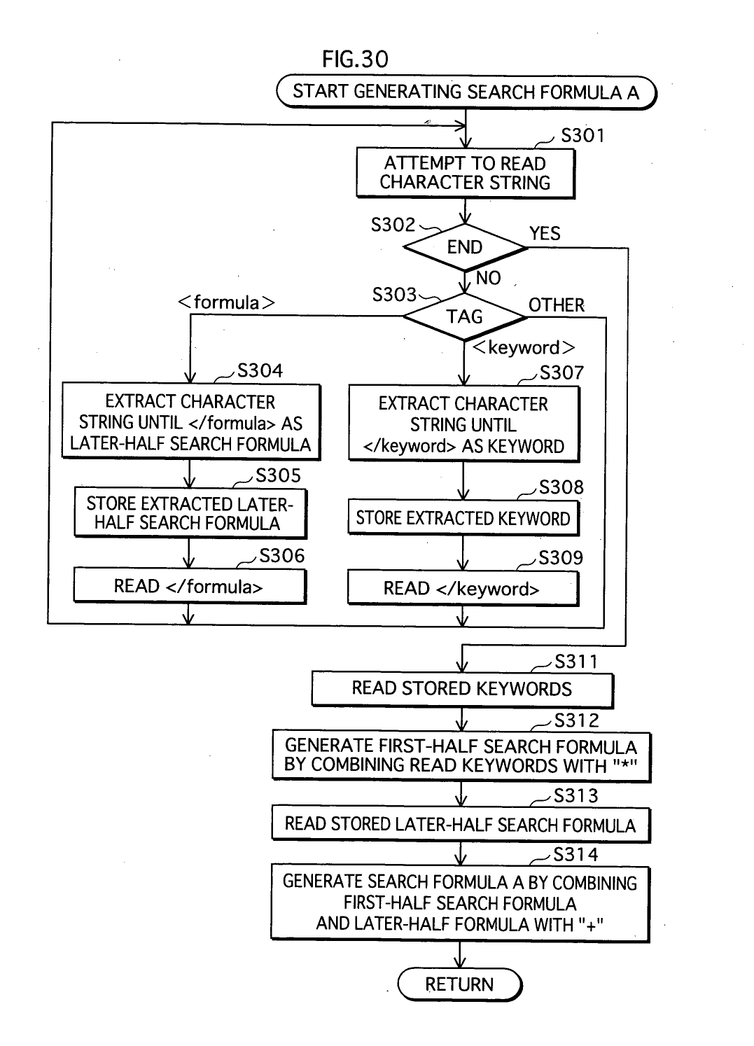

The following describes an operation performed by the interpretation unit 131 to generate the search formula A, with reference to a flow chart shown in FIG. 30.

The interpretation unit 131 attempts to sequentially read a character string one at a time, from the received program recommendation information, beginning with a start of the program recommendation information (step S301). Here, the character string includes “<date>”, “20030707”, and “</date>” included in the date information 421b of the program recommendation information 420 in FIG. 11, and “<keyword>”, “BASEBALL”, and “</keyword>” included in the keyword information 422a. Each of these character strings has a certain meaning by itself. It should be noted that a character string in brackets “<” and “>” is referred to as a tag.

When completing reading all of the character strings from the program recommendation information (step S302), the interpretation unit 131 next performs a control in a step S311.

When not completing reading all of the character strings from the program recommendation information (step S302), the interpretation unit 131 judges whether the read character string is a tag <formula>, a tag <keyword>, or something else.

When judging the read character string to be a tag <formula> (step S303), the interpretation unit 131 extracts a character string between the tag <formula> and a tag </formula>, as a later-half search formula (step S304), stores the extracted later-half search formula (step S305), and reads the tag</formula> (step S306). After this, the interpretation unit 131 repeats the procedure starting from the step S301.

When judging the read character string to be the tag <keyword> (step S303), the interpretation unit 131 extracts a character string between the tag <keyword> and a tag </keyword>, as a keyword (step S307), stores the extracted keyword (step S308), and reads the tag </keyword> (step S309). After this, the interpretation unit 131 repeats the procedure starting from the step S301.

When judging the read character string to be something else (step S303), the interpretation unit 131 repeats the procedure starting from the step S301.

After this, the interpretation unit 131 reads one or more keywords stored therein (step S311). When reading two or more keywords, the interpretation unit 131 combines the keywords using a logical AND operation symbol “*”, to generate a first-half search formula (step S312), and reads one or more later-half search formulas stored therein (step S313).

When reading one later-half search formula, the interpretation unit 131 generates the search formula A by combining the generated first-half search formula and the read later-half search formula using a logical OR operation symbol “+”. When reading two or more later-half search formulas, the interpretation unit 131 generates the search formula A by combining the generated first-half search formula and the read later-half search formulas using a logical OR operation symbol “+” (step S314).

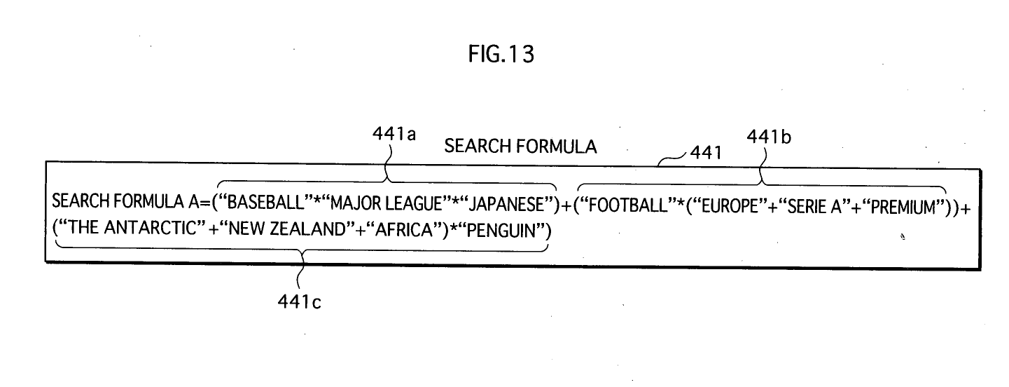

FIG. 13 shows an example of the search formula A generated by the interpretation unit 131.

A search formula 441 shown in FIG. 13 is generated by the interpretation unit 131 based on the program recommendation information 420 shown in FIG. 11.

The search formula 441 shown in FIG. 13 is expressed by combining, using logical OR operation symbols,

a logical expression 441a (“BASEBALL”*“MAJOR LEAGUE”*“JAPANESE”),

a logical expression 441b (“FOOTBALL”*(“EUROPE”+“SERIE A”+“PREMIUM”)), and

a logical expression 441c ((“THE ANTARCTIC”+“NEW ZEALAND”+“AFRICA”)*“PENGUIN”).

The logical expression 441a is generated based on the keyword area 422 in the program recommendation information 420 shown in FIG. 11.

The logical expressions 441b and 441c are respectively generated based on the search formula information 423a and search formula information 423b in the search formula area 423 in the program recommendation information 420.

(ii) Interpretation Unit 133

The interpretation unit 133 receives program recommendation information from the program recommendation information input unit 124.

When receiving the program recommendation information, the interpretation unit 133 generates a search formula B based on the received program recommendation information, and outputs the generated search formula B to the operation unit 132, similarly to the interpretation unit 131.

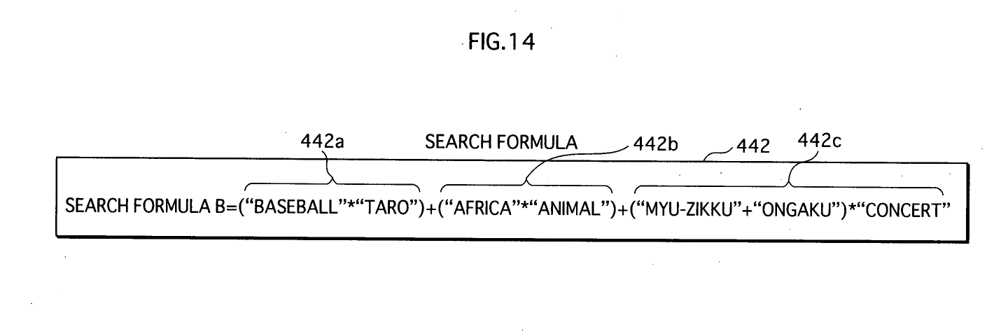

FIG. 14 shows an example of the search formula B generated by the interpretation unit 133.

A search formula 442 shown in FIG. 14 is generated by the interpretation unit 133 based on the program recommendation information 430 shown in FIG. 12.

The search formula 442 shown in FIG. 14 is expressed by combining, using logical OR operation symbols,

a logical expression 442a (“BASEBALL”*“TARO”),

a logical expression 442b (“AFRICA”*“ANIMAL”), and

a logical expression 442c (“MUSIC”+“MUSIC”)*“CONCERT”.

The logical expression 442a is generated based on the keyword area 432 in the program recommendation information 430 shown in FIG. 12. The logical expressions 442b and 442c are respectively generated based on the search formula information 433a and search formula information 433b in the search formula area 433 in the program recommendation information 430.

(iii) Operation Unit 132

The operation unit 132 receives the search formula A from the interpretation unit 131, and the search formula B from the interpretation unit 133.

When receiving the search formulas A and B, the operation unit 132 combines the received search formulas A and B using a logical OR operation symbol, to generate program search information, and outputs the generated program search information to the search unit 123 and conversion unit 134.

The program search information=the search formula A+the search formula B

According to the above description, the operation unit 132 uses a logical OR operation to combine the search formulas A and B. However, the operation unit 132 may instead use any of a logical AND operation, a logical exclusive OR operation, a logical NOT operation, a logical N AND operation, and a logical NOR operation.

Furthermore, the operation unit 132 may use a combination of two or more of the logical operations including a logical OR operation, a logical AND operation, a logical exclusive OR operation, a logical NOT operation, a logical N AND operation, and a logical NOR operation.

(iv) Conversion Unit 134

The conversion unit 134 receives the program search information from the operation unit 132, and generates program recommendation information based on the received program search information.

Specifically speaking, the conversion unit 134 separates the received program search information by referring to a logical OR operation symbol, to generate one or more search formulas. The conversion unit 134 then adds tags <formula> and </formula> respectively in front and at rear of each of the search formulas, to generate a plurality of pieces of search formula information. After this, the conversion unit 134 adds tags <formula_list> and </formula_list> respectively in front and at read of a group of the generated pieces of search formula information. The tags <formula_list> and </formula_list> identify a search formula area. The conversion unit 134 further adds necessary information.

In this way, the conversion unit 134 generates program recommendation information similar to the program recommendation information 420 shown in FIG. 11. The program recommendation information generated by the conversion unit 134 is different from the program recommendation information 420, in that the former does not include a presetting information area and a keyword area.

Subsequently, the conversion unit 134 writes the generated program recommendation information into the program recommendation information storage unit 126.

(e) Search Unit 123

The search unit 123 reads the EPG data from the EPG data storage unit 104, and receives the program search information from the operation unit 132.

When receiving the program search information, the search unit 123 judges whether any of summaries in multiple pieces of broadcast program information in the read EPG data satisfies a condition shown by the program search information. The search unit 123 designates broadcast program information that satisfies the condition, as program presetting information.

In this way, the search unit 123 generates one or more pieces of program presetting information. Here, each of the pieces of program presetting information includes a reception channel, starting date and time, a duration, a summary, and a cast list, which respectively correspond to a broadcast channel, starting date and time, a duration, a summary, and a cast list included in broadcast program information. After this, the search unit 123 outputs the generated pieces of program presetting information to the record presetting control unit 107 and playback presetting information generation unit 108.

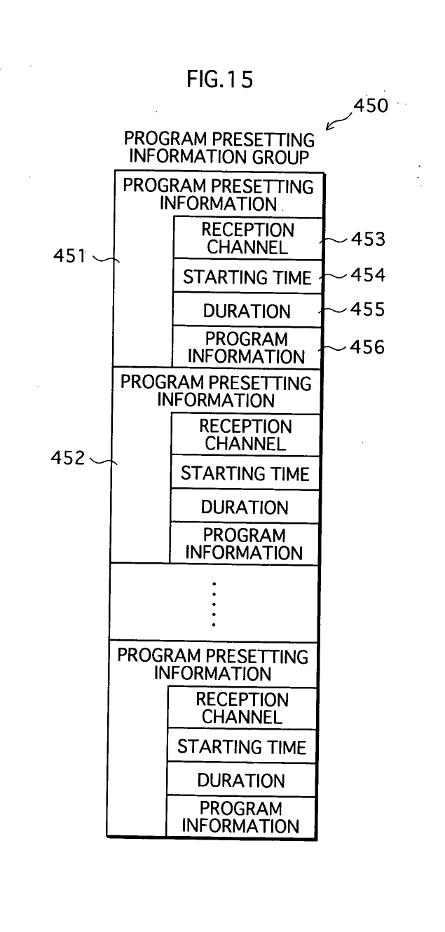

FIG. 15 shows, as an example, the one or more pieces of program presetting information generated by the search unit 123. As shown in FIG. 15, the one or more pieces of program presetting information constitute a program presetting information group 450. The program presetting information group 450 includes program presetting information 451, 452, . . . . Each piece of program presetting information includes a reception channel, a starting time, a duration, and program information.

(f) Program Recommendation Information OUTPUT Unit 125

The program recommendation information output unit 125 receives a designation of program recommendation information from the remote controller 200, via the input unit 112 and control unit 111. The program recommendation information output unit 125 then reads the designated program recommendation information from the program recommendation information storage unit 126, and outputs the read program recommendation information to an external apparatus, via the communication unit 115 and Internet 10.

Here, such an external apparatus is the recording/playback apparatus 100b, for example.

However, the external apparatus is not limited to the recording/playback apparatus 100b, and may be a different recording/playback apparatus or computer system.

(9) Record Presetting Information Storage Unit 113

The record presetting information storage unit 113 has an area to store a record presetting information group including one or more pieces of record presetting information.

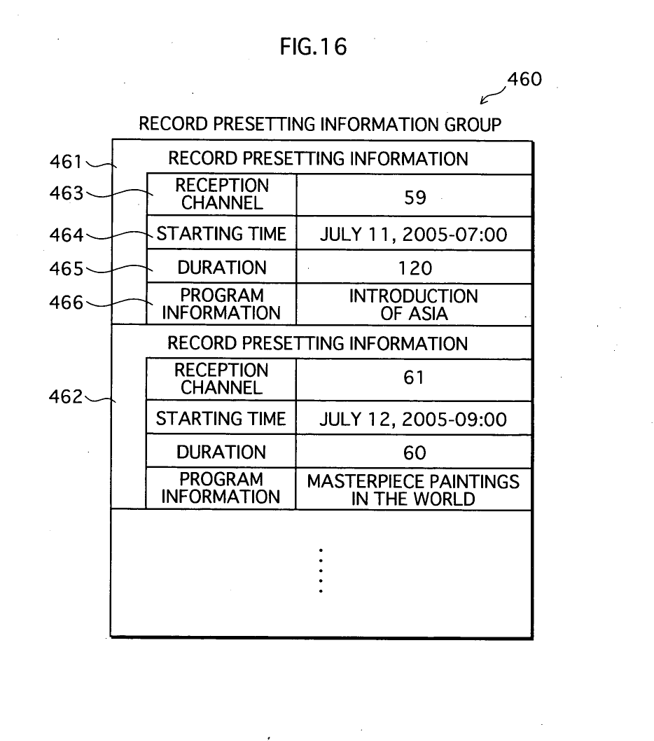

FIG. 16 shows an example of a record presetting information group.

A record presetting information group 460 shown in FIG. 16 includes record presetting information 461, 462, . . . .

Each piece of record presetting information corresponds to one program, and includes a reception channel, a starting time, a duration, and program information.

The reception channel identifies a channel on which the program is broadcast, the starting time indicates a date (year, month, and day) and a time (in hours and minutes) when broadcasting of the program starts, the duration indicates a time period from a broadcast starting time to a broadcast ending time of the program, and the program information includes a summary and a cast list of the program.

(10) Record Presetting Control Unit 107

The record presetting control unit 107 receives one or more pieces of program presetting information from the program presetting information generation unit 116. When receiving the one or more pieces of program presetting information, the record presetting control unit 107 writes the received pieces of program presetting information into the record presetting information storage unit 113, as one or more pieces of record presetting information.

Also, the record presetting control unit 107 reads record presetting information from the record presetting information storage unit 113. Based on the read record presetting information, the record presetting control unit 107 judges whether to output a recording instruction or recording end instruction to the recording unit 105. In accordance with the result of the judgment, the record presetting control unit 107 outputs a recording instruction or recording end instruction, to the recording unit 105.

(Output of Recording Instruction OR Recording End Instruction)

The record presetting control unit 107 has a recording flag, which indicates whether the recording unit 105 is writing audio-visual information into the content storage unit 106, i.e. whether recording is in process. When the recording flag is set to “0”, recording is not in process. When the recording flag is set to “1”, recording is in process.

The following describes an operation of the record presetting control unit 107, with reference to a flow chart shown in FIG. 25.

The record presetting control unit 107 sets an initial value of the recording flag to “0”, and sets a point, which indicates one of the pieces of record presetting information in a record presetting information group, so as to indicate an initial piece of record presetting information in the record presetting information group (step S161).

After this, the record presetting control unit 107 attempts to read the piece of record presetting information indicated by the point, from the record presetting information group stored in the record presetting information storage unit 113 (step S162).

When completing reading all the pieces of record presetting information from the record presetting information group, i.e. when there is no longer record presetting information which is to be indicated by the point (step S163), the record presetting control unit 107 sets the point to indicate the initial-piece of record presetting information in the record presetting information group (step S179). Subsequently, the record presetting control unit 107 repeats a procedure starting from the step S162.

When not completing reading all the pieces of record presetting information from the record presetting information group (step S163), the record presetting control unit 107 extracts a starting time from read record presetting information (step S164), and also obtains a current time (step S165). Then, the record presetting control unit 107 compares a recording time that is equivalent to two seconds before the starting time, with the obtained current time. If the recording time matches the current time (step S166), the record presetting control unit 107 extracts a reception channel from the read record presetting information (step S168), outputs the extracted reception channel to the tuner unit 102 (step S169), outputs a recording instruction instructing a start of recording of audio-visual information, to the recording unit 105 (step S170), sets the recording flag to “1” (step S171), extracts a duration from the read record presetting information (step S172), and calculates an ending time based on the following equation.

The ending time=the starting time+the duration (step S173)

The record presetting control unit 107 obtains a current time (step S178). Following this, the record presetting control unit 107 repeats a procedure starting from the step S175.

When the recording time does not match the current time (step S166), the record presetting control unit 107 judges whether the recording flag is set to “0” or “1”. When judging the recording flag to be set to “0” (step S174), the record presetting control unit 107 moves, in increment of one, the point indicating record presetting information that is to be read from the record presetting information group (step S180). After this, the record presetting control unit 107 repeats the procedure starting from the step S162.

When judging the recording flag to be set to “1” (step S174), the record presetting control unit 107 compares a recording end time that is equivalent to one second after the calculated ending time, with the current time. If the recording end time matches the current time (step S175), the record presetting control unit 107 outputs a recording end instruction indicating an end of recording of audio-visual information, to the recording unit 105 (step S176), and sets the recording flag to “0” (step S177). After this, the record presetting control unit 107 repeats the procedure starting from the step S180.

When the recording end time does not match the current time as a result of the comparison (step S175), the record presetting control unit 107 obtains a current time (step S178). Subsequently, the record presetting control unit 107 repeats the procedure starting from the step S175.

(11) Playback Presetting Information Storage Unit 114

The playback presetting information storage unit 114 has an area to store a playback presetting information group, a program guide, and a recorded program table.

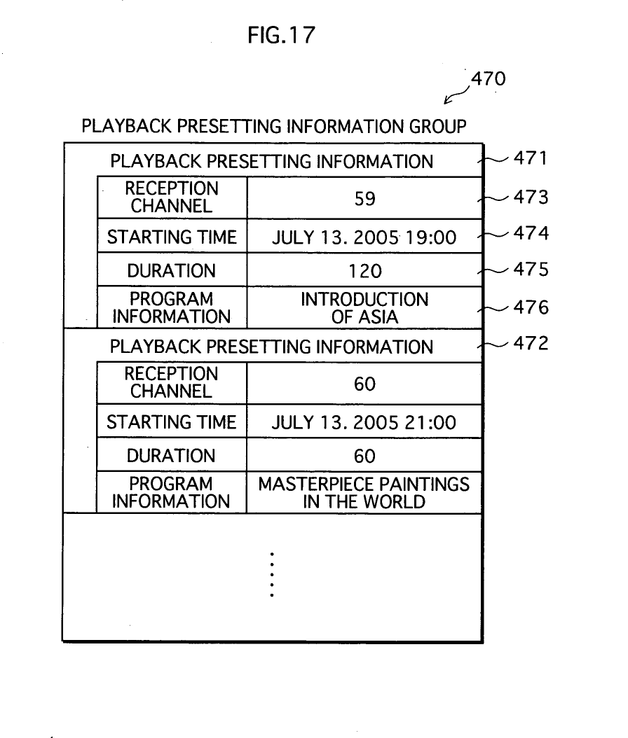

FIG. 17 shows an example of a playback presetting information group.

A playback presetting information group 470 shown in FIG. 17 includes playback presetting information 471, 472, . . . .

Each piece of playback presetting information corresponds to one program, and includes a reception channel, a starting time, a duration, and program information.

The reception channel, starting time, duration, and program information in the playback presetting information are respectively the same as the reception channel, starting time, duration, and program information included in the record presetting information, and therefore not described here.

(12) Playback Presetting Information Generation Unit 108

The playback presetting information generation unit 108 receives one or more pieces of program presetting information from the program presetting information generation unit 116. When receiving the one or more pieces of program presetting information, the playback presetting information generation unit 108 writes the received pieces of program presetting information into the playback presetting information storage unit 114, as one or more pieces of playback presetting information.

(Generation of Program Guide)

The playback presetting information generation unit 108 reads all of the pieces of playback presetting information from the playback presetting information storage unit 114, and the EPG data from the EPG data storage unit 104.

After this, the playback presetting information generation unit 108 forms and arranges a plurality of frames in a two-dimensional matrix, with broadcast channels being plotted along an abscissa axis in a predetermined order, and times being plotted along an ordinate axis in an ascending order.

Subsequently, the playback presetting information generation unit 108 selects a frame, out of the plurality of frames, for each piece of broadcast program information included in the read EPG data. The frame selection is made according to a broadcast channel and starting date and time included in each piece of broadcast program information. The playback presetting information generation unit 108 places, in the selected frame, a summary and a cast list included in the piece of broadcast program information.

After this, the playback presetting information generation unit 108 designates one of the broadcast channels in the matrix of frames, selects one of the frames belonging to the designated broadcast channel, according to a starting time included in each of the read pieces of playback presetting information, and places, in the selected frame, program information included in the piece of playback presetting information.

In the manner described above, the playback presetting information generation unit 108 generates a program guide 531 shown in FIG. 21, as an example. In a designated column 532 in this program guide 531, programs indicated by the read pieces of playback presetting information are displayed. On the other hand, in a group of remaining columns 538, programs shown by the EPG data are displayed.

Which is to say, a virtual channel is formed, where multiple pieces of information relating to the plurality of contents indicated by the read pieces of playback presetting information are aligned in a predetermined chronological order. Here, these contents are included in a plurality of pieces of audio-visual information stored in the content storage unit 106. The virtual channel matches the viewer's preference. In the program guide 531, the virtual channel is the program column 532. When the viewer wants to select a content matching his/her preference, s/he can just select a program on the virtual channel.

After this, the playback presetting information generation unit 108 writes the generated program guide into the playback presetting information storage unit 114.

Furthermore, the playback presetting information generation unit 108 reads the program guide from the playback presetting information storage unit 114, and outputs the read program guide to the playback unit 109, in response to an instruction from the control unit 111.

Furthermore, the playback presetting information generation unit 108 reads a playback presetting information group from the playback presetting information storage unit 114, and realigns the pieces of playback presetting information included in the read playback presetting information group, in accordance with a predetermined condition, for example, in the order of starting times. Thus, the playback presetting information generation unit 108 generates a recorded program table formed by there aligned pieces of playback presetting information, and writes the generated recorded program table into the playback presetting information storage unit 114.

Also, the playback presetting information generation unit 108 reads the recorded program table from the playback presetting information storage unit 114, and outputs the read recorded program table to the playback unit 109, in response to an instruction from the control unit 111.

In the manner described above, the playback presetting information generation unit 108 generates a recorded program table 541 shown in FIG. 22 as an example. The recorded program table 541 includes a plurality of sets of a reception channel, a starting time (in hours and minutes), and a title of a program.

(13) Playback Unit 109

The playback unit 109 receives the program guide or recorded program table from the playback presetting information generation unit 108, and outputs the received program guide or recorded program table to the output unit 110, in response to an instruction from the control unit 111.

Furthermore, in response to an instruction from the control unit 111, the playback unit 109 reads audio-visual information from the content storage unit 106, i.e. a program, decrypts the read program, to generate visual information and audio information, and outputs the generated visual information and audio information to the output unit 110.

(14) GUI Generation Unit 117

The GUI generation unit 117 generates graphical user interface (GUI) information, which provides a variety of necessary information to the viewer, enables the viewer to make an input, and gives a warning or the like to the viewer. The GUI generation unit 117 outputs the generated GUI information to the output unit 110. This can provide various kinds of information to the viewer.

The GUI generation unit 117 prestores thereon menu screen information that is used to generate a menu screen 501 shown in FIG. 18. As shown in FIG. 18, the menu screen 501 includes a title “MENU”, selections 502, 503, 504, 505, . . . . The title is written with “MENU”, and the selections 502, 503, 504, 505, . . . are respectively written with “SELECTING DIFFERENT USER'S PROGRAM RECOMMENDATION INFORMATION, “SELECTING YOUR OWN PROGRAM RECOMMENDATION INFORMATION”, “GENERATING PROGRAM PRESETTING INFORMATION”, “OUTPUTTING PROGRAM RECOMMENDATION INFORMATION”, . . . .

The menu screen 501 is displayed by the monitor 119 when the user operates the operation button 213 of the remote controller 200.

The GUI generation unit 117 reads the menu screen information from within, and outputs the read menu screen information to the output unit 110, in response to a control performed by the control unit 111.

(15) Output Unit 110

The output unit 110 receives the visual information and audio information, program guide, or recorded program table, from the playback unit 109, and receives the GUI information from the GUI generation unit 117. The output unit 110 converts the received visual information and audio information, program guide, recorded program table, or GUI information, into analog visual and audio signals, and outputs the generated visual and audio signals to the monitor 119.

(16) Control Unit 111

The control unit 111 controls the constituents of the recording/playback apparatus 100. The control unit 111 is described in detail later.

(17) Communication Unit 115

The communication unit 115 is connected to an external apparatus via the Internet 10. Thus, the communication unit 115 enables information to be transferred between the external apparatus and program presetting information generation unit 116.

1.4 Operation of Recording/Playback Apparatus 100

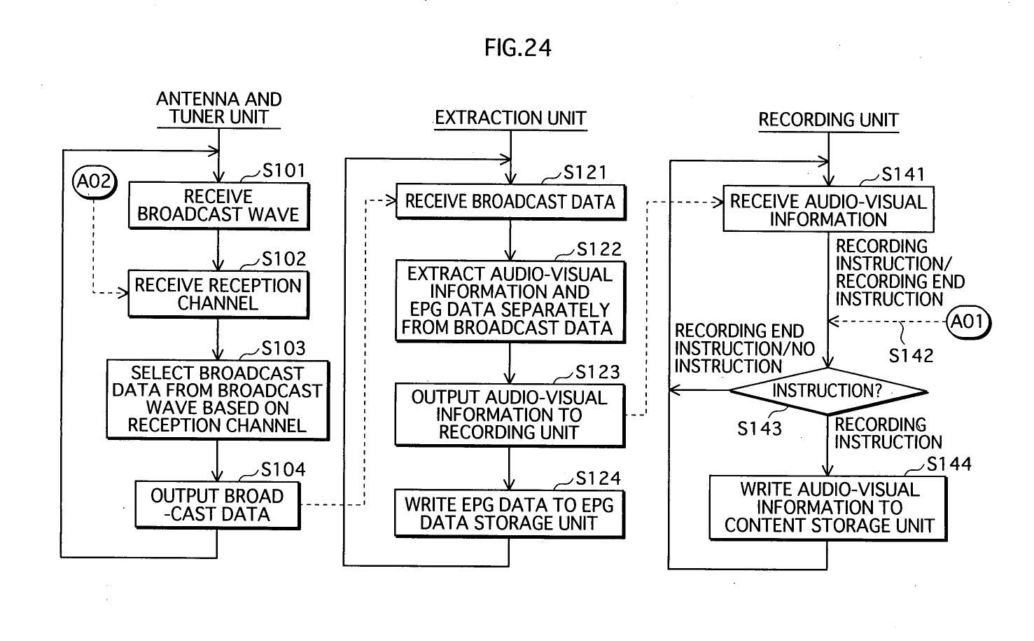

The following describes an operation of the recording/playback apparatus 100, with reference to the flow charts shown in FIGS. 24 to 30.

(1) Operations of Antenna 101, Tuner Unit 102, Extraction Unit 103, and Recording Unit 105

The following describes operations of the antenna 101, tuner unit 102, extraction unit 103, and recording unit 105, with reference to the flow charts shown in FIG. 24.

The antenna 101 and tuner unit 102 receive broadcast waves (step S101), receive a reception channel from the recording presetting control unit 107 (step S102), select broadcast data from the broadcast waves based on the reception channel (step S103), and outputs the selected broadcast data to the extraction unit 103 (step S104). After this, the antenna 101 and tuner unit 102 repeat the procedure starting from the step S101.

The extraction unit 103 receives the broadcast data from the tuner unit 102 (step S121), extracts audio-visual information and EPG data separately from the received broadcast data (step S122), outputs the extracted audio-visual information to the recording unit 105 (step S123), and writes the extracted EPG data to the EPG data storage unit 104 (step S124).

The recording unit 105 receives the audio-visual information from the extraction unit 103 (step S141).

The recording unit 105 receives a recording instruction or recording end instruction, from the user's operation, via the remote controller 200, input unit 112 and control unit 111, or from the record presetting control unit 107 (step S142).

When receiving a recording instruction (step S143), the recording unit 105 writes the audio-visual information received from the extraction unit 103 into the content storage unit 106 (step S144). After this, the recording unit 105 repeats the procedure starting from the step S141.

When receiving a recording end instruction, or no instruction (step S143), the recording unit 105 stops writing the audio-visual information received from the extraction unit 103 into the content storage unit 106. After this, the recording unit 105 repeats the procedure starting from the step S141.

(2) Operation of Record Presetting Control Unit 107

The operation of the record presetting control unit 107 has been described above with reference to the flow chart shown in FIG. 25.

(3) Operation of Control Unit 111

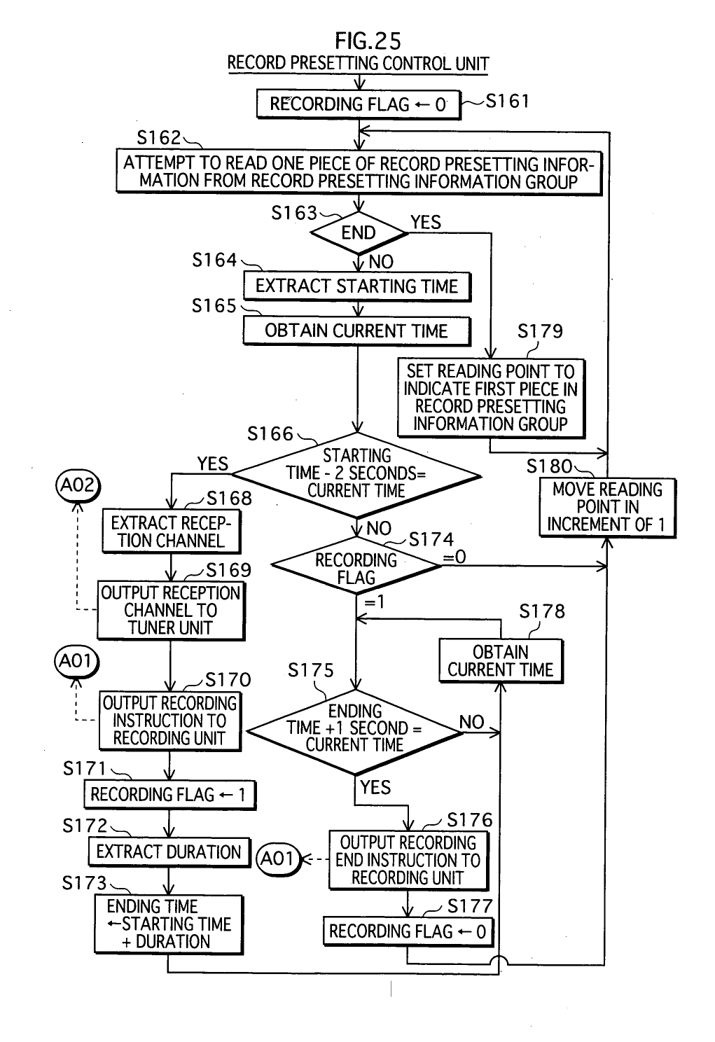

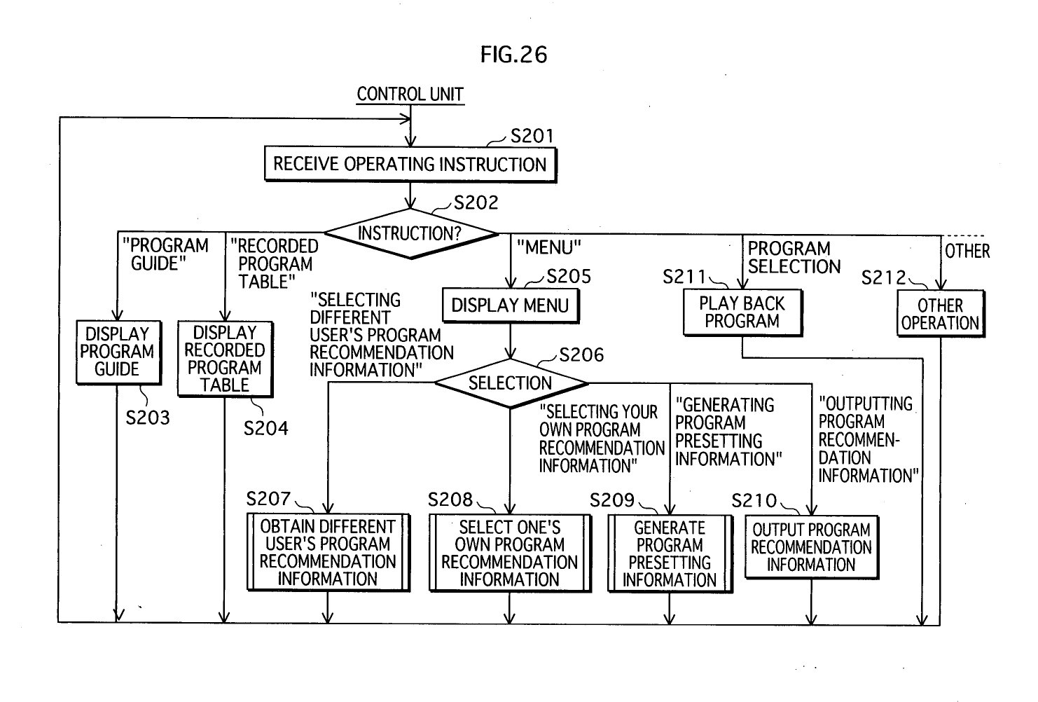

The following mainly describes the operation of the control unit 111, with reference to the flow chart shown in FIG. 26.

The control unit 111 receives the user's operating instruction from the remote controller 200, via the input unit 112 (step S201), and judges which one of “PROGRAM GUIDE”, “RECORDED PROGRAM TABLE”, “MENU”, “PROGRAM SELECTION”, and other instruction is indicated by the operating instruction (step S202).

When judging the operating instruction indicates “PROGRAM GUIDE” (step S202), the control unit 111 gives an instruction to the playback presetting information generation unit 108. In response to this instruction from the control unit 111, the playback presetting information generation unit 108 reads a program guide from the playback presetting information storage unit 114, and outputs the read program guide to the playback unit 109, so that the monitor 119 displays the program guide 531 shown in FIG. 21 (step S203). After this, the control unit 111 repeats the procedure starting from the step S201.

When judging the operating instruction indicates “RECORDED PROGRAM TABLE” (step S202), the control unit 111 gives an instruction to the playback presetting information generation unit 108. In response to this instruction from the control unit 111, the playback presetting information generation unit 108 reads a recorded program table from the playback presetting information storage unit 114, and outputs the read recorded program table to the playback unit 109, so that the monitor 119 displays the recorded program table 541 shown in FIG. 22 (step S204). After this, the control unit 111 repeats the procedure starting from the step S201.

When judging the operating instruction indicates “MENU” (step S202), the control unit 111 instructs the GUI generation unit 117 to generate the menu screen 501 shown in FIG. 18. Accordingly, the GUI generation unit 117 reads, from within, the menu screen information to achieve display of the menu screen 501, and outputs the read menu screen information to the output unit 110, so that the monitor 119 displays the menu screen 501 shown in FIG. 18. Following this, the control unit 111 receives the user's operating instruction from the remote controller 200 via the input unit 112 (step S205), and judges which one of “SELECTING DIFFERENT USER'S PROGRAM RECOMMENDATION INFORMATION, “SELECTING YOUR OWN PROGRAM RECOMMENDATION INFORMATION”, “GENERATING PROGRAM PRESETTING INFORMATION”, and “OUTPUTTING PROGRAM RECOMMENDATION INFORMATION” is indicated by the operating instruction (step S206).

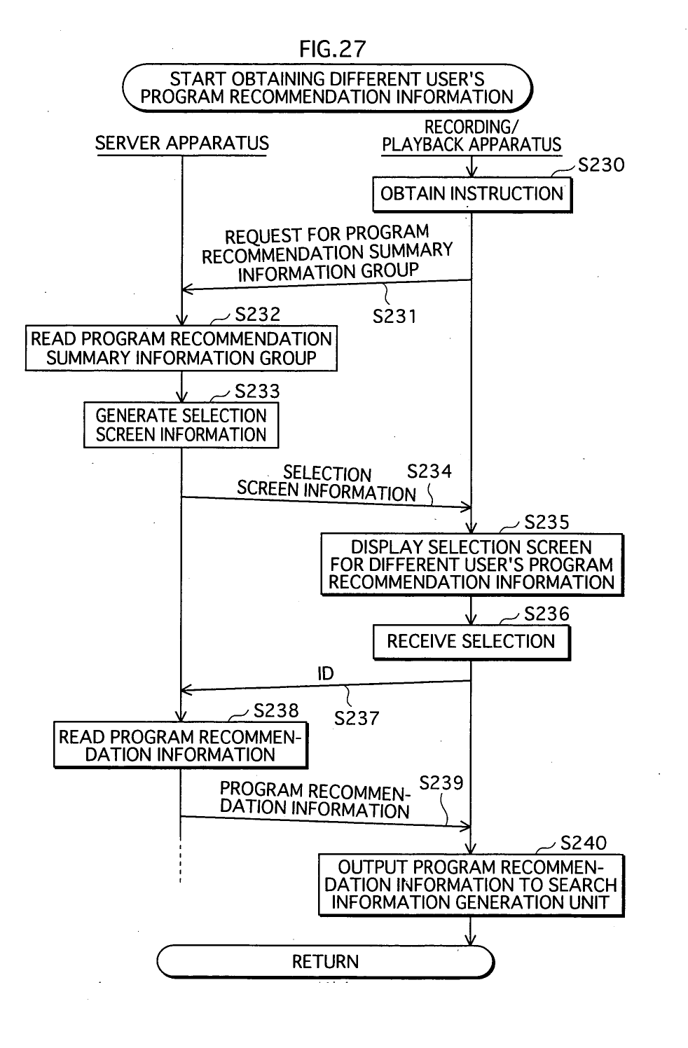

When judging that the operating instruction indicates “SELECTING DIFFERENT USER'S PROGRAM RECOMMENDATION INFORMATION” (step S206), the control unit 111 obtains a different user's program recommendation information according to the procedure shown in the flow chart of FIG. 27 (step S207). After this, the control unit 111 repeats the procedure starting from the step S201.

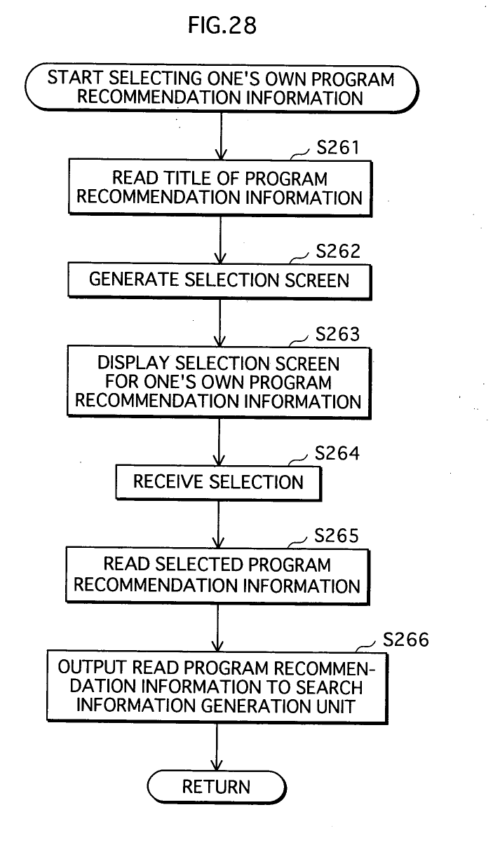

When judging that the operating instruction indicates “SELECTING YOUR OWN PROGRAM RECOMMENDATION INFORMATION” (step S206), the control unit 111 obtains the user's own program recommendation information according to the procedure shown in the flow chart of FIG. 28 (step S208). After this, the control unit 111 repeats the procedure starting from the step S201.

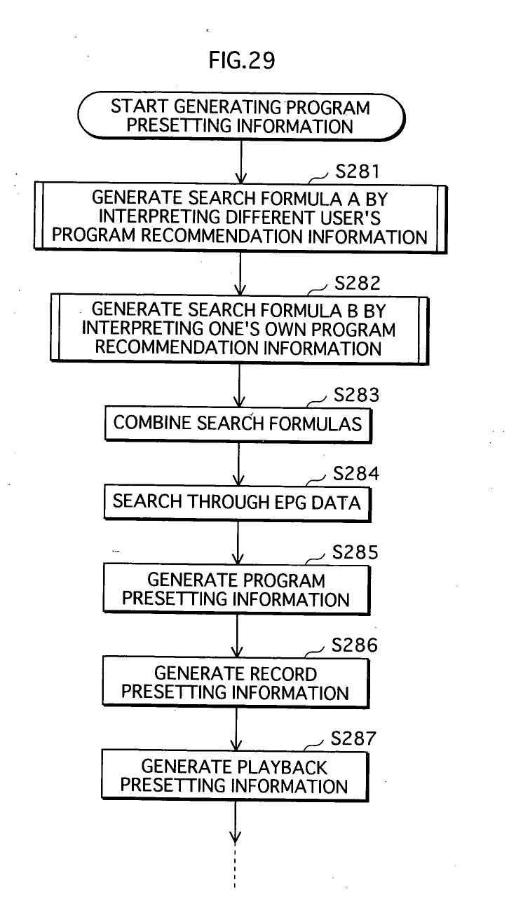

When judging that the operating instruction indicates “GENERATING PROGRAM PRESETTING INFORMATION” (step S206), the control unit 111 generates program presetting information according to the procedure shown in the flow chart of FIG. 29 (step S209). After this, the control unit 111 repeats the procedure starting from the step S201.

When the control unit 111 judges that the operating instruction indicates “OUTPUTTING PROGRAM RECOMMENDATION INFORMATION” (step S206), the program recommendation information output unit 125 receives a designation of program recommendation information from the remote controller 200, via the input unit 112 and control unit 111, reads the designated program recommendation information from the program recommendation information storage unit 126, and outputs the read program recommendation information to the recording/playback apparatus 100b via the communication unit 115 and Internet 10 (step S210). After this, the control unit 111 repeats the procedure starting from the step S201.

When the control unit 111 judges that the operating instruction indicates “PROGRAM SELECTION” (step S202), the playback unit 109 reads audio-visual information designated by the control unit 111, from the content storage unit 106, and decrypts the read audio-visual information, to obtain visual information and audio information. The output unit 110 converts the visual information and audio information into analog image and sound signals, and the monitor 119 outputs images and sounds (step S211). After this, the control unit 111 repeats the procedure starting from the step S201.

When the control unit 111 judges that the operating instruction indicates other instruction (step S202), an operation appropriate for the instruction is performed. After this, the control unit 111 repeats the procedure starting from the step S201.

(4) Operations of Program Recommendation Information INPUT Unit 121 and Server Apparatus 300

The following describes an operation performed by the program recommendation information input unit 121 to obtain a different user's program recommendation information, with reference to the flow chart shown in FIG. 27.

The program recommendation information input unit 121 receives, from the control unit 111, an instruction to obtain a different user's program recommendation information from an external apparatus (step S230), and then transmits a request for a program recommendation summary information group, to the server apparatus 300, via the communication unit 115 and Internet 10 (step S231).

The control unit 302 receives the request for a program recommendation summary information group, from the recording/playback apparatus 100, via the Internet 10 and communication unit 301 (step S231). After this, the control unit 302 reads the program recommendation summary information group 311 from the information storage unit 303 (step S232), extracts an ID and a title from each of the pieces of program recommendation summary information included in the read program recommendation summary information group, and generates selection screen information to form a selection screen, using the extracted IDs and titles (step S233). Subsequently, the control unit 302 transmits the generated selection screen information to the recording/playback apparatus 100, via the communication unit 301 and Internet 10 (step S234).

Following this, the program recommendation information input unit 121 receives the selection screen information from the server apparatus 300, via the Internet 10 and communication unit 115 (step S234), and outputs the received selection screen information to the output unit 110, so that the monitor 119 displays a selection screen for a different user's program recommendation information (step S235).

Subsequently, the program recommendation information input unit 121 receives an ID identifying program recommendation information from the input unit 112, via the control unit 111 (step S236), transmits the received ID to the server apparatus 300 via the communication unit 115 and Internet 10 (step S237). The control unit 302 receives the ID identifying program recommendation information from the recording/playback apparatus 100, via the Internet 10 and communication unit 301 (step S237), reads the program recommendation information assigned with the received ID, from the information storage unit 303 (step S238), and transmits the read program recommendation information to the recording/playback apparatus 100 via the communication unit 301 and Internet 10 (step S239).

After this, the program recommendation information input unit 121 receives the program recommendation information identified by the ID, from the server apparatus 300, via the Internet 10 and communication unit 115 (step S239), and outputs the received program recommendation information to the search information generation unit 122 (step S240).

(5) Operation of Program Recommendation Information Input Unit 124

The following describes an operation performed by the program recommendation information input unit 124 to select the user's own program recommendation information, with reference to the flow chart shown in FIG. 28.

The program recommendation information input unit 124 reads a title indicating each piece of program recommendation information from the program recommendation information storage unit 126 (step S261), generates the selection screen 521 (shown in FIG. 20) including the display unit 525 having a list of the read titles, the button 524, and other display parts and buttons (step S262), and outputs the generated selection screen 521 to the output unit 110. Thus, the monitor 119 displays the selection screen 521 (step S263).

After this, the program recommendation information input unit 124 receives a designation of program recommendation information from the remote controller 200, via the input unit 112 and control unit 111 (step S264), reads the designated program recommendation information from the program recommendation information storage unit 126 (step S265), and outputs the read program recommendation information to the search information generation unit 122 (step S266).

(6) Operation of Search Information Generation Unit 122

The following describes an operation of the search information generation unit 122, with reference to the flow chart shown in FIG. 29.

The interpretation unit 131 receives a different user's program recommendation information from the program recommendation information input unit 121, generates the search formula A based on the received program recommendation information, and outputs the generated search formula A to the operation unit 132 (step S281).

The interpretation unit 133 receives the user's own program recommendation information from the program recommendation information input unit 124, generates the search formula B based on the received program recommendation information, and outputs the generated search formula B to the operation unit 132 (step S282).

The operation unit 132 receives the search formula A from the interpretation unit 131, and the search formula B from the interpretation unit 133. Then, the operation unit 132 combines the received search formulas A and B by a logical OR operation, thereby generating program search information, and outputs the generated program search information to the search unit 123 and conversion unit 134 (step S283).

The search unit 123 reads the EPG data from the EPG data storage unit 104, receives the program search information from the operation unit 132. Thus, the search unit 123 searches through the read EPG data (step S284), in order to judge whether any of the summaries included in multiple pieces of broadcast program information in the read EPG data satisfies a condition shown by the program search information. The search unit 123 designates broadcast program information that is judged to satisfy the condition, as program presetting information, and outputs the program presetting information to the record presetting control unit 107 and playback presetting information generation unit 108 (step S285).

The record presetting control unit 107 receives one or more pieces of program presetting information from the program presetting information generation unit 116, and writes the received pieces of program presetting information into the record presetting information storage unit 113, as one or more pieces of record presetting information (step S286).

The playback presetting information generation unit 108 receives one or more pieces of program presetting information from the program presetting information generation unit 116, and writes the received pieces of program presetting information into the playback presetting information storage unit 114, as one or more pieces of playback presetting information (step S287).

(7) Operations of Interpretation Unit 131 and Interpretation Unit 133

The above has described the operations performed by the interpretation units 131 and 133 to generate the search formulas A and B respectively, with reference to the flow chart shown in FIG. 30.

1.5 Conlusion

The recording/playback apparatus described above obtains a different user's program recommendation information, and selects the user's own program recommendation information. The recording/playback apparatus then generates search formulas based on the respective pieces of program recommendation information, and combines the generated search formulas, to generate a search formula. The recording/playback apparatus then searches through EPG data using the generated search formula, to generate program presetting information. The recording/playback apparatus records broadcast audio-visual information, and plays back the recorded audio-visual information, in accordance with the generated program presetting information.

In the manner described above, this recording/playback apparatus can record and play back a program matching a common preference between a different user's program recommendation information and the user's own program recommendation information.

### 2. MODIFICATION EXAMPLES

The present invention is not limited to the above-described embodiment, and further includes the following modification examples.

(1) According to the above description, the recording/playback apparatus 100 performs a record presetting and a playback presetting (hereinafter referred to as a first-type operation). However, the present invention is not limited to such.

The recording/playback apparatus 100 may be configured to only perform a record presetting (hereinafter referred to as a second-type operation). If this is the case, the program presetting information generation unit 116 outputs program presetting information to the record presetting control unit 107, but not to the playback presetting information generation unit 108.

The recording/playback apparatus 100 may be configured to perform a selected one of the first-type and second-type operations. If this is the case, the viewer instructs which one of the first-type and second-type operations is performed by the recording/playback apparatus 100. The control unit 111 receives this instruction from the remote controller 200, via the input unit 112. In accordance with this instruction, the control unit 111 controls the program presetting information generation unit 116 so as to perform an appropriate one of the first-type and second-type operations. Here, when playing back a stored content, the viewer individually designates a desired one of one or more pieces of audio-visual information stored in the content storage unit 106.

When receiving an instruction for the first-type operation, the program presetting information generation unit 116 outputs program presetting information to the record presetting control unit 107 and playback presetting information generation unit 108. When receiving an instruction for the second-type operation, the program presetting information generation unit 116 outputs program presetting information only to the record presetting control unit 107.

(2) According to the above-described recording/playback apparatus 100, the program recommendation information input unit 121 can obtain program recommendation information from an external source, and the program recommendation information output unit 125 can output program recommendation information to an external source. With this construction, the viewer can watch a program matching, for example, a celebrity's preference, by obtaining a different user's program recommendation information. In addition, the viewer can provide his/her own program recommendation information to other users.

The recording/playback apparatus 100 can obtain and output program recommendation information, via a digital network such as the Internet and cable television. For example, suppose program recommendation information is put on the Internet. In this case, a viewer can obtain a different viewer's program recommendation information by downloading or uploading program recommendation information.

(3) As mentioned in the above description, program recommendation information is text information. Therefore, a viewer can generate new program recommendation information, or edit existing program recommendation information, by using, for example, an editor which is a computer program realizing input, edition, and output of text information. In detail, a viewer may add a search formula, a keyword, a comment, and the like to program recommendation information on a computer system such as a personal computer.

Here, the computer system may be connected to the recording/playback apparatus 100 via a network, so that the recording/playback apparatus 100 can obtain program recommendation information from the computer system.

Furthermore, the computer system may write program recommendation information into a portable recording medium, so that the recording/playback apparatus 100 reads program recommendation information from the recording medium.

Moreover, the recording/playback apparatus 100 may transmit program recommendation information, which is generated or edited by the computer system, via a digital network, or output program recommendation information using a recording medium, to a different user's computer system or recording/playback apparatus.

Thus, the viewer can give or sell program recommendation information edited by himself/herself, via a digital network, or using a recording medium.

According to the above embodiment, a different user's program recommendation information is supplied by the server apparatus 300, to a recording/playback apparatus, via a digital network such as the Internet. However, the present invention is not limited to such.

As an alternative example, the broadcasting apparatus owned by a broadcaster may broadcast a different user's program recommendation information, via digital broadcasting, and a recording/playback apparatus may receive broadcast waves, and extract the different user's program recommendation information from the received broadcast waves.

(4) According to the above embodiment, the program presetting information generation unit 116 uses the program recommendation information 420 obtained by the program recommendation information input unit 121, and the program recommendation information 430 prestored in the program recommendation information storage unit 126 and selected by the program recommendation information input unit 124, when generating program search information by performing a logical operation. However, the present invention is not limited to such.

As an alternative example, program recommendation information stored in the program recommendation information storage unit 126 may not be used. In this case, the program recommendation information input unit 121 obtains multiple pieces of program recommendation information, the interpretation unit 131 generates search formulas respectively corresponding to the multiple pieces of program recommendation information, and the operation unit 132 combines these search formulas, to generate program search information.

With this construction, the interpretation unit 133 and program recommendation information input unit 124 are no longer necessary. This means that the program presetting information generation unit 116 can be realized by using a simpler construction. Furthermore, the program presetting information generation unit 116 performs a logical operation based on multiple pieces of program recommendation information generated by multiple users, which are obtained from an external source. This can meet various needs of viewers.

(5) According to the above embodiment, logical OR and AND operations are taken as an example of a logical operation performed on search information such as a keyword. However, the present invention is not limited to these logical operations.

Here, the recording/playback apparatus 100 may perform a variety of logical operations on the user's own program recommendation information and a different user's program recommendation information, as mentioned above. Alternatively, the recording/playback apparatus 100 may perform a variety of logical operations on multiple pieces of the user's own program recommendation information, or on multiple pieces of a different user's program recommendation information.

By using a logical AND operation, common data can be extracted from multiple pieces of data. Accordingly, when a logical AND operation is performed on multiple pieces of program recommendation information of multiple viewers, a group of programs that interest all of the viewers commonly can be extracted. This is suitable for a case where each family member brings his/her own program recommendation information, for example.

When a logical OR operation is utilized, a group of programs that interests all of the viewers can be extracted.

When a logical NOT operation is utilized, programs that are not suitable for children can be avoided, and programs belonging to a genre to which the user normally pays no attention can be recommended, for example. Furthermore, particular programs (programs that have turned out to be uninteresting or infamous) may be excluded from an existing set of programs. As seen from these examples, the present invention can meet users' meticulous requests. For example, it is assumed that program ID information (hereinafter referred to as “ID”) of a program which is desired to be excluded from a set of programs is available. Here, if the user wants this program to be excluded from a predetermined set “Z”, a set

“Z” AND NOT (“ID”)

may be extracted. In this way, the user can watch programs in the set “Z”, excluding a program identified by the particular program ID information “ID”.

When a logical N AND operation is utilized in a case where multiple viewers watch a program together, a set of programs that match a preference of none of the viewers can be selected.

When a logical XOR (EOR) operation is utilized, recommended programs match a preference (specialization) of only one of the viewers. This can help the viewers to expand their preferences.

The present invention can meet a variety of demands of viewers, in addition to those mentioned above.

For example, a viewer may have multiple pieces of program recommendation information for different purposes such as self-improvement, leisure (overseas travels), and leisure (major leagues). In this case, the viewer can watch a desired program matching any of these-meticulously classified preferences, by performing a logical operation on the multiple pieces of program recommendation information.

The recording/playback apparatus 100 relating to the above embodiment can perform a combination operation equivalent to a combination of multiple logical operations, on program recommendation information. The following shows an example of an operation equivalent to a combination of multiple logical operations.

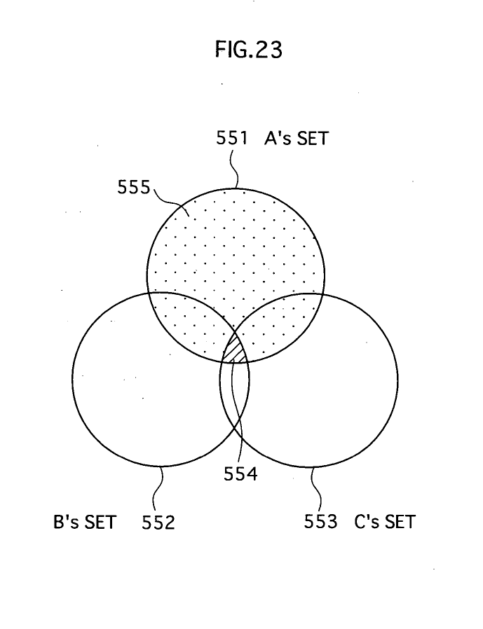

FIG. 23 is used to explain a case where an operation equivalent to a combination of multiple logical operations is performed by the program presetting information generation unit 116 relating to the above embodiment.

As shown in FIG. 23, it is assumed that there is an overlap among a set 551 of programs (hereinafter referred to as a set A) extracted based on program recommendation information of a viewer A, a set 552 of programs (hereinafter referred to as a set B) extracted based on program recommendation information of a viewer B, and a set 553 of programs (hereinafter referred to as a set C) extracted based on program recommendation information of a viewer C.

When the viewers A, B and C watch a program together, a logical AND operation is performed on the three sets. In other words, a logical operation

“A” AND “B” AND “C”

is performed, and a set 554 is obtained. In this way, the viewers A, B and C can watch a program that matches a common preference between all of them.

Here, the viewer A may watch a program by himself/herself, before watching a program together with the other viewers B and C. In this case, the viewer A may want to watch a program that matches his/her own preference, but is not included in the set of programs that will be later watched together with the viewers B and C. Therefore, a logical operation

“A” AND (NOT (“A” AND “B” AND “C”))

is performed, and a set 555 is obtained. Thus, the viewer A can watch a program that is included in his/her own set A, but not included in the set of programs that are to be later watched together with the other viewers B and C.

By performing a logical NOT operation, a parent can exclude inappropriate programs for his/her child, from a set of programs the child wants to watch. In this case, the parent may generate a search formula X in advance, for example. The search formula X is formed by combining multiple pieces of keyword information representing programs which the parent thinks are inappropriate for the child.

The search formula X “violence”+“crime”

(Hereinafter, a set of programs extracted based on the search formula X is expressed with “X”.)

Here, a search formula Y representing a set of programs the child wants to watch is assumed to be as follows.

The search formula Y “animation”+“hero”+“special effects”

(Hereinafter, a set of programs extracted based on the search formula Y is expressed with “Y”.)

Here, when the following search formula including a logical NOT operation,

“Y” AND (NOT “X”) is utilized, an extracted set of programs are the programs left after excluding the set “X” of the programs which the parent thinks are inappropriate for the child, from the set “Y” of the programs the child wants to watch.

(6) By conducting communication with different apparatuses via a digital network, multiple viewers may transmit and receive program recommendation information using their recording/playback apparatuses positioned away from one another. Thus, the viewers can watch a program matching a common preference between them.

With the recording/playback apparatus relating to the above embodiment, a viewer may add program ID information indicating a program and whether the program is recommended or not, after watching the program, to program recommendation information, and transmit this program recommendation information including the program ID information, to a recording/playback apparatus owned by a different viewer.

As mentioned above, program recommendation information may have program presetting information directly written therein. Such program recommendation information can meet a viewer's demand that keyword information and search formula information are preferably not published to other viewers, but a set of recommended programs is desirably published.

(7) Program recommendation information described above can realize a website service where various pieces of program recommendation information are put on the Internet for free or profit. Also, a community is hopefully formed to discuss topics such as how to select keyword information included in program recommendation information and methods to generate search formulas based on keyword information.

(8) The above embodiment discloses a recording/playback apparatus including a program presetting information generation unit, as an example. However, the present invention is not limited to such.

As an alternative example, a recording apparatus which records a program based on program presetting information obtained by a program presetting information generation unit may be provided. Also, a playback apparatus which plays back a program based on program presetting information obtained by a program presetting information generation unit may be provided.

The program presetting information generation unit relating to the above embodiment may be mounted on a digital recorder such as DVD and HDD recorders, or on a device such as a Set Top Box (STB).

(9) Program recommendation information described above can be modified.

The presetting information area 421 in the program recommendation information 420 shown in FIG. 11 may include time zone information, a region code identifying a region, and the like, in light of time differences between regions, and different broadcast channels between regions. Furthermore, the presetting information area 421 may store program ID information such as G-codes (registered trade mark) without a change, for example.

Furthermore, the presetting information area 421 may include a title of the program recommendation information, and information indicating a person or group of people who has created the program recommendation information, for example. In addition, the presetting information area 421 may include, for example, a comment field in which a user's or group of people's comment about the program recommendation information is written.

In a case where a comment about program recommendation information is written in such a comment field, a viewer can know credibility and reliability of the program recommendation information by referring to the comment, when obtaining the program recommendation information from a different viewer. Furthermore, a viewer can add his/her own comment about program recommendation information, to the program recommendation information. Thus, by giving the program recommendation information to a different viewer, for example, the viewer can tell other viewers his/her own opinion.

(10) Program recommendation information described above can be further modified.

According to the above description, program recommendation information includes a presetting information area (program presetting information), a keyword area (keyword information), and a search formula area (search formula information), in the stated order. However, this order can be freely changed.

Furthermore, program recommendation information may only include one or two of program presetting information, keyword information, and search formula information.

In addition, program recommendation information may be configured to include viewing permission information indicating whether a viewer has a viewing permission of a particular channel or program. Viewing permission information is determined by whether the viewer has a contract or not, and by various management policies of each channel. For example, such management policies indicate a channel is a charge-free channel, and the viewer can therefore watch programs on this channel for all day, or indicate a channel is a charged channel, but on charge-free days, the viewer can watch programs on this channel without a contract with this channel.

Here, when generating program presetting information, the search unit 123 in the recording/playback apparatus 100 searches through the information stored in the EPG data storage unit 104. By referring to viewing permission information, the search unit 123 can search only through channels and programs the viewer is permitted to watch, excluding channels and programs the viewer is not permitted to watch. This enables the search to be performed effectively.

When there are channels or programs that the search unit 123 does not search through as mentioned above, the program presetting information generation unit 116 may warn the viewer, for instance, by giving off or displaying an abnormal signal. Here, contract information for the viewer is held in the program presetting information generation unit 116 in the recording/playback apparatus 100.

Program recommendation information used by the program presetting information generation unit 116 may include identification information identifying a viewer or group of viewers who has generated the program recommendation information.

According to the above embodiment, program recommendation information is written in XML as an example, but not limited to such. As an alternative example, program recommendation information may be text or binary data having a defined data structure, or written in a markup language other than XML.

(11) The program recommendation information input unit 121 and program recommendation information output unit 125 may be capable of communicating with an external apparatus, directly, via the communication unit 115 including a modem, LAN and the like, or via a digital network such as the Internet and cable television. Here, the external apparatus is, for example, a server storing a plurality of pieces of program recommendation information, or another recording/playback apparatus.

If this is the case, the communication can be attained by using an appropriate known communication means such as infrared rays, the Internet, and electric waves. Here, the present invention is not limited to a particular type of digital network.

The program recommendation information input unit 121 and program recommendation information output unit 125 may be respectively configured to receive and send program recommendation information, by reading/writing information from/into a known storage medium such as a semiconductor memory, a disc device, and a DVD. Here, the present invention is not limited to a particular type of storage medium.

The program recommendation information input unit 121 may be configured to receive multiple pieces of program recommendation information, and the program recommendation information output unit 125 may be configured to output multiple pieces of program recommendation information.

(12) The above-described construction of the program presetting information generation unit 116 can be modified. For example, the program recommendation information input unit 121 obtains and stores program recommendation information into the program recommendation information storage unit 126 without any change. In this case, the operation unit 132 performs a combination operation, on multiple pieces of program recommendation information selected in response to the viewer's input, from multiple pieces of program recommendation information stored in the program recommendation information storage unit 126.

(13) The interpretation units 131 and 133 included in the search information generation unit 122 may be formed by using an XML parser that interprets XML, when both types of program recommendation information are written in XML.

The interpretation units 131 and 133 are not limited to be formed by using an XML parser. The interpretation units 131 and 133 can be formed by using anything that has a function of interpreting program recommendation information so as to generate search information.

According to the above embodiment, the interpretation units 131 and 133 are separate units. However, a single interpretation unit can also realize the interpretation functions.

(14) In a case where the recording/playback apparatus 100 has only one tuner unit mounted therein, the recording/playback apparatus 100 can not record all programs broadcast on different channels for the same time period. Therefore, when the search done by the search unit 123 shows programs whose broadcast time periods overlap each other, the search unit 123 may generate an abnormal signal indicating the overlap, to output a display or sound of an error message designated to the viewer, to the monitor 119 via the output unit 110. Alternatively, the search unit 123 may enable the viewer to select a desired program from the programs whose broadcast time periods overlap each other.

This construction is not necessary when the recording/playback apparatus 100 has a plurality of tuner units 102 mounted therein, because, in this case, record presettings can be made for programs whose broadcast time periods overlap each other.

(15) The search unit 123 and the constituents of the search information generation unit 122 in the recording/playback apparatus 100, i.e. the interpretation unit 131, operation unit 132, interpretation unit 133, and conversion unit 134 may be realized by using a hardware constituted by a logic circuit, or by a computer program executable on a CPU.

(16) According to the above embodiment, the program recommendation information input unit 124 generates the selection screen 521 shown in FIG. 20, and outputs the generated selection screen 521 to the output unit 110. However, the present invention is not limited to such.

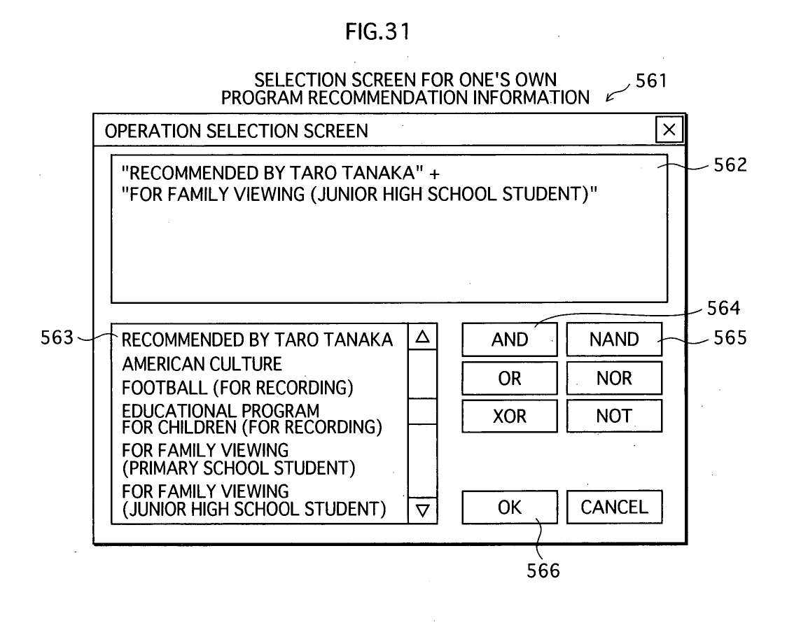

Alternatively, the program recommendation information input unit 124 may generate a selection screen 561 shown in FIG. 31. As shown in FIG. 31, the selection screen 561 is formed by a display part 562 displaying a combination of titles each showing program recommendation information, a display part 563 displaying a list of titles read from the program recommendation information storage unit 126, a button 564 displaying “AND”, a button 565 displaying “NAND”, a plurality of buttons respectively displaying other logical operators, a button 566 displaying “OK”, and a button displaying “CANCEL”. The program recommendation information input unit 124 outputs the generated selection screen 561 to the output unit 110. Thus, the selection screen 561 is displayed by the monitor 119.

Following this, the program recommendation information input unit 124 receives a designation of one or more titles indicating one or more pieces of program recommendation information and a designation of one or more logical operators, from the remote controller 200, via the input unit 112 and control unit 111. Based on the received titles and logical operators, the program recommendation information input unit 124 combines two titles with one logical operator. Here, if only one title is received, the combination is the received title itself. After this, the program recommendation information input unit 124 writes the combination into the display part 562. Then, the program recommendation information input unit 124 outputs the selection screen 561 to the output unit 110 again, so that the monitor 119 displays the selection screen 561.

Subsequently, the program recommendation information input unit 124 receives an input of “OK” from the remote controller 200, via the input unit 112 and control unit 111, reads one or more pieces of program recommendation information from the program recommendation information storage unit 126, which are indicated by the received one or more titles, and outputs the read pieces of program recommendation information to the search information generation unit 122, together with one or more logical operators, if any logical operators are designated.

In the manner described above, a plurality of pieces of program recommendation information can be selected, and one or more logical operators indicating operations to be performed among the selected pieces of program recommendation information can be determined.

(17) Program presetting information can be generated so as to satisfy a group of viewers also in the following manner.

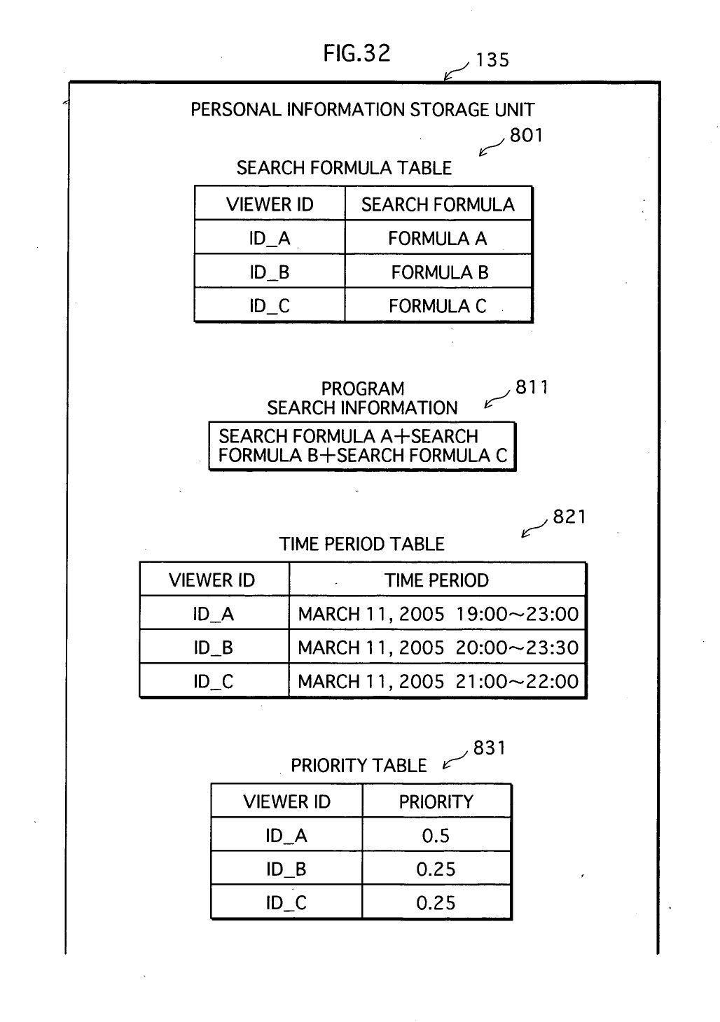

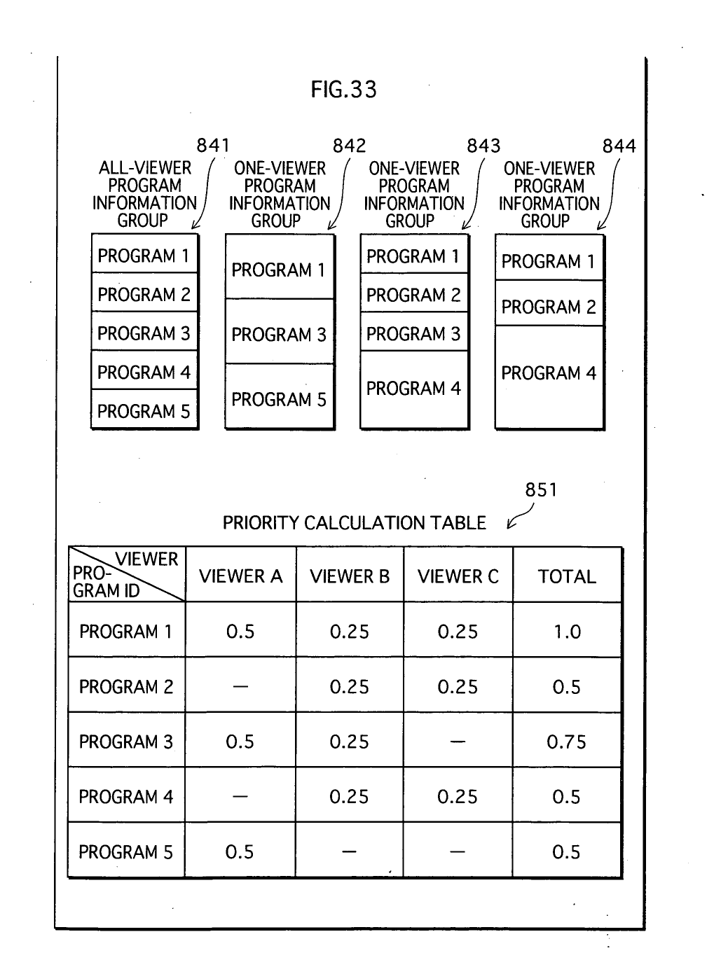

As shown in FIGS. 32 and 33, the program presetting information generation unit 116 may further include a personal information storage unit 135. The personal information storage unit 135 has an area to store a search formula table 801, program search information 811, a time period table 821, a priority table 831, an all-viewer program information group 841, and one-viewer program information groups 842 to 844.

The program recommendation information input unit 124 receives a viewer ID identifying a viewer and a selection of program recommendation information made by the viewer, with regard to each of multiple viewers.

The interpretation unit 133 generates search formulas based on these pieces of program recommendation information received by the program recommendation information input unit 124. The interpretation unit 133 then writes the generated search formulas in association with the viewer IDs, into the personal information storage unit 135, as the search formula table 801. In this way, the search formula table 801 stores a plurality of combinations of a viewer ID and a search formula. Here, each of the search formulas stored in the search formula table 801 indicates one or more programs recommended for a corresponding viewer, and may alternatively be referred to as “recommended program information”.

Alternatively, the search formula table 801 may be configured to store, in association with each viewer ID, program search information generated by the program recommendation system 1 relating to the above embodiment. Here, the program search information is obtained, for each viewer, by combining two search formulas respectively generated based on the viewer's own program recommendation information and a different viewer's program recommendation information. This program search information may be also alternatively referred to as “recommended program information”.

The interpretation unit 133 combines the search formulas in the search formula table 801, which are generated based on multiple pieces of program recommendation information, to generate the program search information 811. The interpretation unit 133 writes the generated program search information 811 into the personal information storage unit 135.

As shown in FIG. 32, the program search information 811 is expressed as “SEARCH FORMULA A+SEARCH FORMULA B+SEARCH FORMULA C”, as an example. The symbol “+” indicates a logical OR operation.

As shown in FIG. 32, the personal information storage unit 135 prestores the time period table 821. The time period table 821 stores a time period for which each of the viewers can watch programs. In detail, the time period table 821 stores a plurality of pieces of time period information. Each piece of time period information includes a viewer ID and time period information. The viewer ID is an identification code for identifying a viewer. The time period information indicates a time period for which the corresponding viewer can watch programs, and includes a starting date (year, month and day) and time (in hours and minutes) and an ending time (in hours and minutes) of this time period.

For example, it is assumed that there are three viewers A, B and C. The viewer A can watch programs during a time period of 19:00 to 23:00 on Mar. 11, 2005. The viewer B can watch programs during a time period of 20:00 to 23:30 on Mar. 11, 2005. The viewer C can watch programs during a time period of 21:00 to 22:00 on Mar. 11, 2005. The time period table 821 stores these time periods in association with the corresponding viewer IDs. Here, the time period table 821 may store a plurality of time periods in association with each viewer ID.

As shown in FIG. 32, the personal information storage unit 135 further prestores the priority table 831. The priority table 831 indicates a priority for each of the viewers. The priority table 831 stores the same number of pieces of priority information as the number of the viewers. Each piece of priority information includes a viewer ID and a priority. The viewer ID is an identification code identifying a viewer as mentioned above, and the priority indicates a priority index assigned to the corresponding viewer. A predetermined operation is preferentially performed for a viewer assigned with a higher priority, when compared with a viewer assigned with a lower priority.

According to the priority table 831, specifically speaking, the viewer A is assigned with a priority of 0.5, the viewer B is assigned with a priority of 0.25, and the viewer C is assigned with a priority of 0.25. The priority table 831 includes priorities and viewer IDs. The sum of the priorities assigned to all of the viewers is equal to 1.0.

The search unit 123 reads the time period table 821 from the personal information storage unit 135. By using the read time period table 821, the search unit 123 extracts a time period shared by all of the viewers, and calculates the length of the shared time period.

Specifically speaking, the search unit 123 reads the time period table 821, extracts a shared time period of 21:00 to 22:00 on Mar. 11, 2005, based on the read time period table 821, and calculates the length of the shared time period. In the above example, the length of the shared time period is one hour.

After this, the search unit 123 reads the EPG data from the EPG data storage unit 104, and the program search information 811 from the personal information storage unit 135. The search unit 123 then searches through the EPG data, and extracts one or more pieces of broadcast program information satisfying the condition shown by the program search information 811. Out of the extracted pieces of broadcast program information, the search unit 123 selects one or more pieces of broadcast program information including a duration equal to or shorter than the calculated length of the shared time period. Specifically speaking, the search unit 123 selects one or more pieces of broadcast program information including a duration equal to or shorter than one hour in this example.

Here, each of the selected pieces of broadcast program information is for all of the viewers, and is hereinafter referred to as all-viewer program information. FIG. 33 shows an example of all-viewer program information. The all-viewer program information group 841 shown in FIG. 33 includes multiple pieces of broadcast program information for “PROGRAM 1”, “PROGRAM 2”, “PROGRAM 3”, “PROGRAM 4”, and “PROGRAM 5”.

Furthermore, the search unit 123 reads the EPG data from the EPG data storage unit 104, and the search formula table 801 from the personal information storage unit 135. Thus, the search unit 123 searches through the read EPG data, so as to extract one or more pieces of broadcast program information satisfying the condition shown by the search formula corresponding to each of the viewer IDs included in the search formula table 801.

Here, each of the extracted pieces of broadcast program information is for one viewer, and is hereinafter referred to as one-viewer program information. FIG. 33 shows an example of one-viewer program information. The one-viewer program information groups 842, 843 and 844 shown in FIG. 33 respectively correspond to the viewers A, B and C. The one-viewer program information group 842 includes multiple pieces of broadcast program information for “PROGRAM 1”, “PROGRAM 3”, and “PROGRAM 5”. The one-viewer program information group 843 includes multiple pieces of broadcast program information for “PROGRAM 1”, “PROGRAM 2”, “PROGRAM 3”, and “PROGRAM 4”. The one-viewer program information group 844 includes multiple pieces of broadcast program information for “PROGRAM 1”, “PROGRAM 2”, and “PROGRAM 4”.

Subsequently, the search unit 123 relates the priorities assigned to the viewers, to broadcast program information included in each piece of all-viewer program information.

This is specifically done in the following manner. The search unit 123 reads the priority of 0.5 assigned to the viewer A from the priority table 831. Considering that the one-viewer program information group 842 includes “PROGRAM 1”, “PROGRAM 3”, and “PROGRAM 5”, the priority of 0.5 is assigned to “PROGRAM 1”, “PROGRAM 3”, and “PROGRAM 5”.

In other words, as shown in a priority calculation table 851 shown in FIG. 33, the priority of 0.5 (the viewer A) is assigned to “PROGRAM 1”, “PROGRAM 3”, and “PROGRAM 5”, but not to “PROGRAM 2” and “PROGRAM 4”.

After this, the search unit 123 reads the priority of 0.25 assigned to the viewer B from the priority table 831. Considering that the one-viewer program information group 843 includes “PROGRAM 1”, “PROGRAM 2”, “PROGRAM 3”, and “PROGRAM 4”, the priority of 0.25 is assigned to “PROGRAM 1”, “PROGRAM 2”, “PROGRAM 3”, and “PROGRAM 4”.

In other words, as shown in the priority calculation table 851 shown in FIG. 33, the priority of 0.25 (the viewer B) is assigned to “PROGRAM 1”, “PROGRAM 2”, “PROGRAM 3” and “PROGRAM 4”, but not to “PROGRAM 5”.

Subsequently, the search unit 123 reads the priority of 0.25 assigned to the viewer C from the priority table 831. Considering that the one-viewer program information group 844 includes “PROGRAM 1”, “PROGRAM 2”, and “PROGRAM 4”, the priority of 0.25 is assigned to “PROGRAM 1”, “PROGRAM 2”, and “PROGRAM 4”.

In other words, as shown in the priority calculation table 851 shown in FIG. 33, the priority of 0.25 (the viewer C) is assigned to “PROGRAM 1”, “PROGRAM 2”, and “PROGRAM 4”, but not to “PROGRAM 3” and “PROGRAM 5”.

In the manner described above, each program is assigned with a priority of a corresponding viewer.

After this, the search unit 123 adds together the priorities assigned to each program, to calculate the sum of the priorities.

Specifically speaking, the sum of the priorities assigned to “PROGRAM 1” is
0.5+0.25+0.25=1.0.

The sum of the priorities assigned to “PROGRAM 2” is
0.25+0.25=0.5.

The sum of the priorities assigned to “PROGRAM 3” is
0.5+0.25=0.75.

The sum of the priorities assigned to “PROGRAM 4”, is
0.25+0.25=0.5.

The sum of the priorities assigned to “PROGRAM 5” is
0.5.

Subsequently, the search unit 123 realigns the program IDs in the descending order of the sums. In this way, the program IDs are arranged in the order of

“PROGRAM 1”, “PROGRAM 3”, “PROGRAM 2”, “PROGRAM 4”, and “PROGRAM 5”.

After this, the search unit 123 realigns a plurality of pieces of program presetting information obtained by a search through the EPG data, in accordance with the order of the programs described above. Then, the search unit 123 outputs a program presetting information group including the realigned pieces of program presetting information, to the playback presetting information generation unit 108.

The playback presetting information generation unit 108 writes the program presetting information group into the playback presetting information storage unit 114, as a playback presetting information group.

The playback unit 109 reads the playback presetting information group from the playback presetting information storage unit 114. The playback unit 109 then generates a recorded program table by arranging programs, in accordance with the order of the programs in the read playback presetting information group. The playback unit 109 outputs the generated recorded program table to the output unit 110, so that the monitor 119 displays the recorded program table.

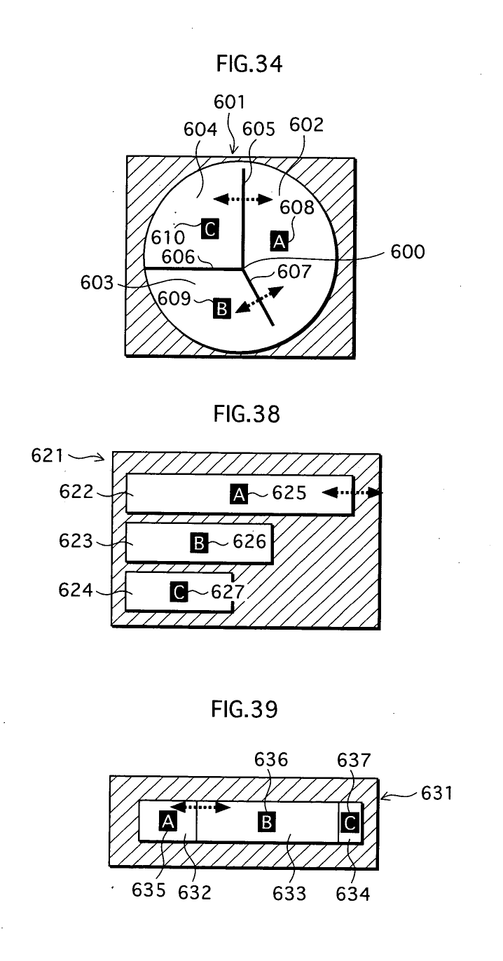

(18) The GUI generation unit 117 may generate a priority input screen 601 shown in FIG. 34, and outputs the generated priority input screen 601 to the output unit 110, so that the monitor 119 displays the priority input screen 601.

The priority input screen 601 includes a plurality of bars 605, 606 and 607 extending radially outward from a point 600. An area 602 between the bars 605 and 607 corresponds to the viewer A, an area 603 between the bars 607 and 606 corresponds to the viewer B, and an area 604 between the bars 606 and 605 corresponds to the viewer C.

The angle formed between the bars 605 and 607 is in proportion to the priority assigned to the viewer A, the angle formed between the bars 607 and 606 is in proportion to the priority assigned to the viewer B, and the angle formed between the bars 606 and 605 is in proportion to the priority assigned to the viewer C.

The areas 602, 603, and 604 respectively include icons 608, 609, and 610 indicating the viewers A, B, and C. The areas 602, 603, and 604 form-sectors with the point 600 being a center.

One of the bars 605, 606, and 607 is selected, and displayed in a selected color for identification. The other two bars are not selected, and displayed in a not-selected color for identification. For example, the selected color is red, and the not-selected color is black. In this way, the selected bar is distinguished by its display color.

It is assumed that a viewer rotates the operation knob 221 of the remote controller 200 to either direction from a starting position 291 shown in FIG. 5 while the priority input screen 601 is displayed. The GUI generation unit 117 receives the angle of the rotation via the input unit 112 and control unit 111, and changes the selected bar, in the order of the bars 605, 606, 607, 605, . . . , in time intervals determined according to the received rotation angle. In detail, the selection of one of the bars 605, 606, and 607 changes at a rate in proportion to the received rotation angle.

Suppose the bar 605 is displayed in the selected color, and the bars 606 and 607 are displayed in the not-selected color. Here, if the viewer rotates the operation knob 221 of the remote controller 200, the GUI generation unit 117 changes the display colors of the bars 605, 606, and 607, so as to display the bar 606 in the selected color, and the bars 605 and 607 in the not-selected color. When a predetermined time elapses after this, the GUI generation unit 117 changes the display colors of the bars 605, 606, and 607, so as to display the bar 607 in the selected color, and the bars 605 and 606 in the not-selected color. In this way, the GUI generation unit 117 sequentially changes the display colors of the bars 605, 606, and 607 as time elapses.

When the viewer lets the operation knob 221 move back to the starting position 291, the GUI generation unit 117 stops changing the display colors of the bars 605, 606, and 607. At this time, the selected bar is displayed in the selected color.

If the viewer subsequently rotates the operation knob 231 of the remote controller 200 to either direction, the GUI generation unit 117 receives an angle of the rotation via the input unit 112 and control unit 111, and rotates the selected bar around the point 600, by the received rotation angle.

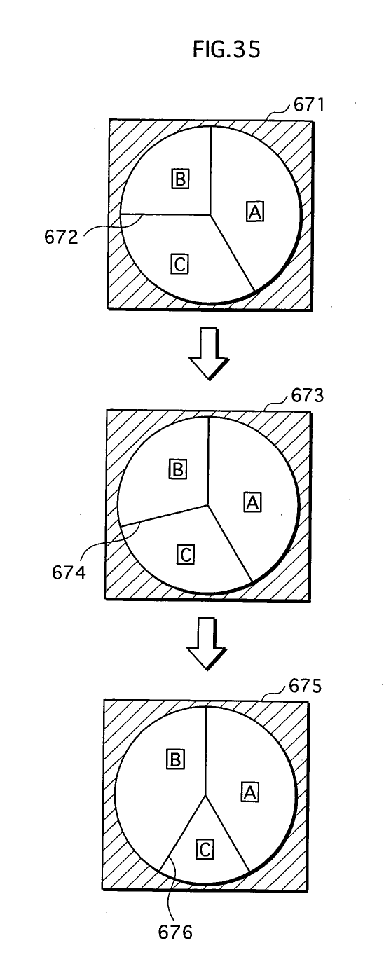

Suppose a bar 672 is selected in a priority input screen 671 shown in FIG. 35. Here, if the operation knob 231 is rotated in anticlockwise direction, the bar 672 moves to a position of a bar 674 shown in a priority input screen 673. If the operation knob 231 is further rotated in anticlockwise direction, the bar 674 moves to a position of a bar 676 shown in a priority input screen 675.

As a result of such an operation, the angle formed between the bars 605 and 607 is in proportion to a new priority assigned to the viewer A, the angle formed between the bars 607 and 606 is in proportion to a new priority assigned to the viewer B, and the angle formed between the bars 606 and 605 is in proportion to a new priority assigned to the viewer C.

The control unit 111 calculates each angle, calculates each viewer's priority based on the calculated angle, and writes the calculated priority into the priority table 831 in the personal information storage unit 135.

Each viewer's priority is calculated according to the following expression.
Priority=An angle formed between bars/360

Note that the unit of measuring the angle is a degree.

In the above description, the priority input screen 601 includes three bars, but not limited to such. The priority input screen 601 may include only two bars, four bars or more. The number of the bars corresponds to the number of the viewers.

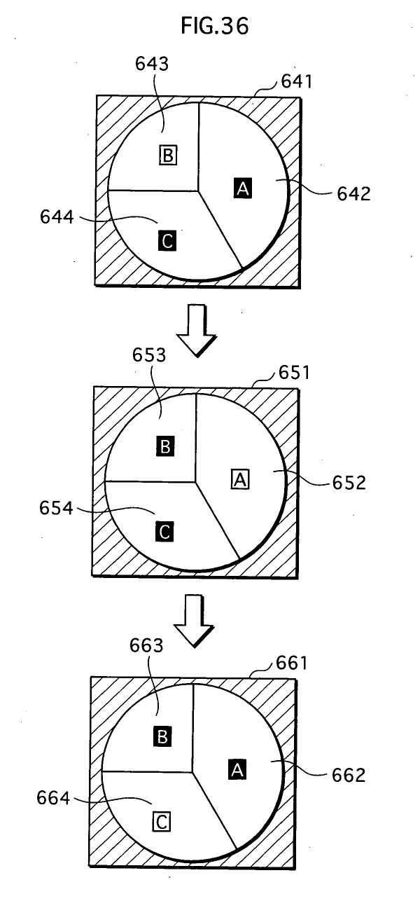

In this modification example, it is the bars whose display colors are changed. In addition, the background colors of the icons displayed in the areas may be also changed as shown in FIG. 36.

In the manner described above, each viewer's priority is input again, and stored. By using each viewer's priority stored in this way, program presetting information for a group of viewers is again generated in the manner described in (17). Based on the generated program presetting information, a recorded program table is generated, and displayed by the monitor 119.

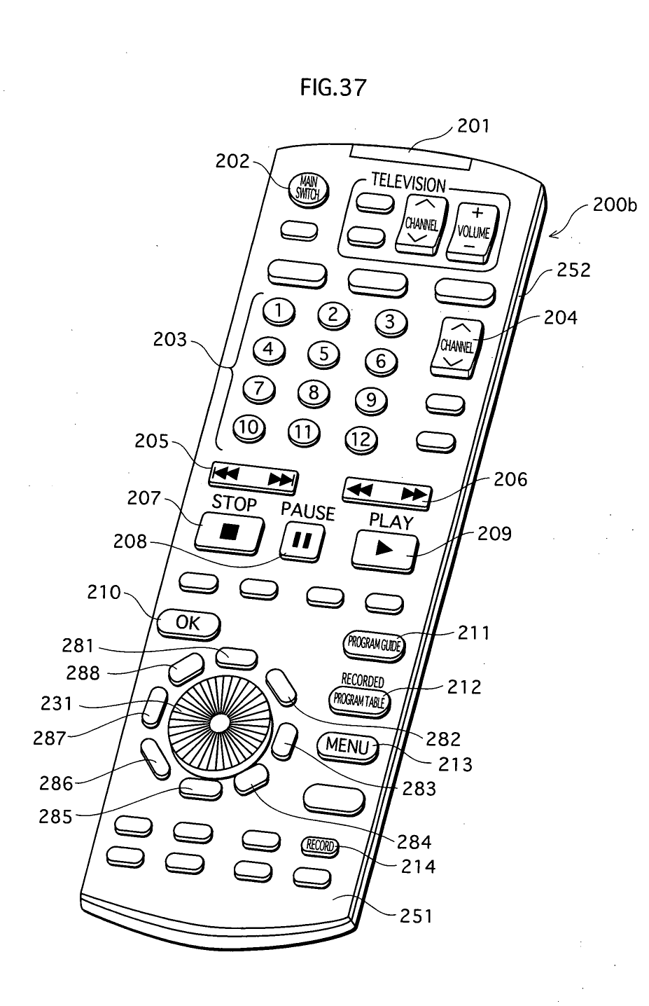

(19) As shown in FIG. 5, the remote controller 200 has the operation knob 221. Instead of the operation knob 221, eight buttons 281 to 288 may be provided around the operation knob 231 as shown in FIG. 37. The eight buttons 281 to 288 respectively correspond to eight directions defined with respect to the axis of the operation knob 231.

By operating any of the buttons 281 to 288, the user can select a bar positioned in a direction corresponding to the position of the operated button.

(20) The GUI generation unit 117 may generate a priority input screen 621 shown in FIG. 38, and output the generated priority input screen. 621 to the output unit 110, so that the monitor 119 displays the priority input screen 621.

The priority input screen 621 includes three rectangles 622, 623 and 624, which respectively correspond to the viewers A, B and C. The rectangles 622, 623 and 624 respectively have lengths in proportion to the priorities of the viewers A, B and C.

The rectangles 622, 623 and 624 respectively have icons 625, 626 and 627 identifying the viewers A, B and C.

One of the rectangles 622, 623 and 624 is selected, and displayed in a selected color for identification. The other two rectangles are not selected, and displayed in a not-selected color for identification.

It is assumed that a viewer rotates the operation knob 221 of the remote controller 200 to either direction from the starting position 291 while the priority input screen 621 is displayed. In this case, the GUI generation unit 117 receives the angle of the rotation via the input unit 112 and control unit 111, and changes the selected rectangle, in the order of the rectangles 622, 623, 624, 622, . . . , in time intervals determined according to the received rotation angle. In detail, the selection of one of the rectangles 622, 623, and 624 changes at a rate in proportion to the received rotation angle.

Suppose the rectangle 622 is displayed in the selected color, and the rectangles 623 and 624 are displayed in the not-selected color. Here, if the viewer rotates the operation knob 221 of the remote controller 200, the GUI generation unit 117 changes the display colors of the rectangles 622, 623 and 624, so as to display the rectangle 623 in the selected color, and the rectangles 622 and 624 in the not-selected color. When a predetermined time elapses after this, the GUI generation unit 117 changes the display colors of the rectangles 622, 623, and 624, so as to display the rectangle 624 in the selected color, and the rectangles 622 and 623 in the not-selected color. In this way, the GUI generation unit 117 sequentially changes the display colors of the rectangles 622, 623, and 624 as time elapses.

When the viewer lets the operation knob 221 move back to the starting position 291, the GUI generation unit 117 stops changing the display colors of the rectangles 622, 623, and 624. At this time, the selected rectangle is displayed in the selected color.

If the viewer subsequently rotates the operation knob 231 of the remote controller 200 to either direction, the GUI generation unit 117 receives an angle of the rotation via the input unit 112 and control unit 111, and moves the right edge of the selected rectangle, according to the received rotation angle.

The distance by which the right edge of the rectangle is moved=the rotation angle/360×100

Note that the unit of measuring the length (including the distance of movement) in the priority input screen 621 is a hundredth of the horizontal length of the priority input screen 621.

As a result of such an operation, the lengths of the rectangles 622, 623, and 624 are respectively in proportion to the new priorities assigned to the viewers A, B and C.

The control unit 111 calculates the length of each rectangle, calculates each viewer's priority based on the calculated length, and writes the calculated priority into the priority table 831 in the personal information storage unit 135.

Each viewer's priority is calculated according to the following expression.
Priority=(the length of the rectangle)/(the sum of the lengths of all the rectangles)

In the above description, the priority input screen 621 includes three rectangles, but not limited to such. The priority input screen 621 may-include only two rectangles, four rectangles or more. The number of the rectangles corresponds to the number of the viewers.

(21) The GUI generation unit 117 may generate a priority input screen 631 shown in FIG. 39, and output the generated priority input screen 631 to the output unit 110, so that the monitor 119 displays the priority input screen 631.

The priority input screen 631 includes one rectangle 638. The rectangle 638 includes partial rectangles 632, 633 and 634, which respectively correspond to the viewers A, B and C. The partial rectangles 632, 633 and 634 respectively have lengths in proportion to the priorities of the viewers A, B and C.

The unit of measuring the length is the same as that explained above.

The partial rectangles 632, 633 and 634 respectively have icons 635, 636 and 637 identifying the viewers A, B and C.

One of the partial rectangles 632, 633 and 634 is selected, and displayed in a selected color for identification. The other two partial rectangles are not selected, and displayed in a not-selected color for identification.

It is assumed that a viewer rotates the operation knob 221 of the remote controller 200 to either direction from the starting position 291 while the priority input screen 631 is displayed. The GUI generation unit 117 receives the angle of the rotation via the input unit 112 and control unit 111, and changes the selected partial rectangle, in the order of the partial rectangles 632, 633, 634, 632, . . . , in time intervals determined according to the received rotation angle. In detail, the selection of one of the partial rectangles 632, 633, and 634 changes at a rate in proportion to the received rotation angle.

Suppose the partial rectangle 632 is displayed in the selected color, and the partial rectangles 633 and 634 are displayed in the not-selected color. Here, if the viewer rotates the operation knob 221 of the remote controller 200, the GUI generation unit 117 changes the display colors of the partial rectangles 632, 633 and 634, so as to display the partial rectangle 633 in the selected color, and the partial rectangles 632 and 634 in the not-selected color. When a predetermined time elapses after this, the GUI generation unit 117 changes the display colors of the partial rectangles 632, 633, and 634, so as to display the partial rectangle 634 in the selected color, and the partial rectangles 632 and 633 in the not-selected color. In this way, the GUI generation unit 117 sequentially changes the display colors of the partial rectangles 632, 633, and 634 as time elapses.

When the viewer lets the operation knob 221 move back to the starting position 291, the GUI generation unit 117 stops changing the display colors of the partial rectangles 632, 633, and 634. At this time, the selected partial rectangle is displayed in the selected color.

If the viewer subsequently rotates the operation knob 231 of the remote controller 200 to either direction, the GUI generation unit 117 receives an angle of the rotation via the input unit 112 and control unit 111, and moves the left or right edge of the selected partial rectangle, according to the received rotation angle. Specifically speaking, in the case of the partial rectangle in contact with the left edge of the rectangle, the right edge is moved. In the case of the partial rectangle in contact with the right edge of the rectangle, the left edge is moved. In the case of the other partial rectangle, the left edge is moved.

As a result of such an operation, the lengths of the partial rectangles 632, 633, and 634 are respectively in proportion to the new priorities assigned to the viewers A, B and C.

The control unit 111 calculates the length of each partial rectangle, calculates each viewer's priority based on the calculated length, and writes the calculated priority into the priority table 831 in the personal information storage unit 135.

Each viewer's priority is calculated according to the following expression.
Priority=(the length of the partial rectangle)/(the length of the rectangle)

In the above description, the priority input screen 631 includes three partial rectangles, but not limited to such. The priority input screen 631 may include only two partial rectangles, four partial rectangles or more. The number of the partial rectangles corresponds to the number of the viewers.

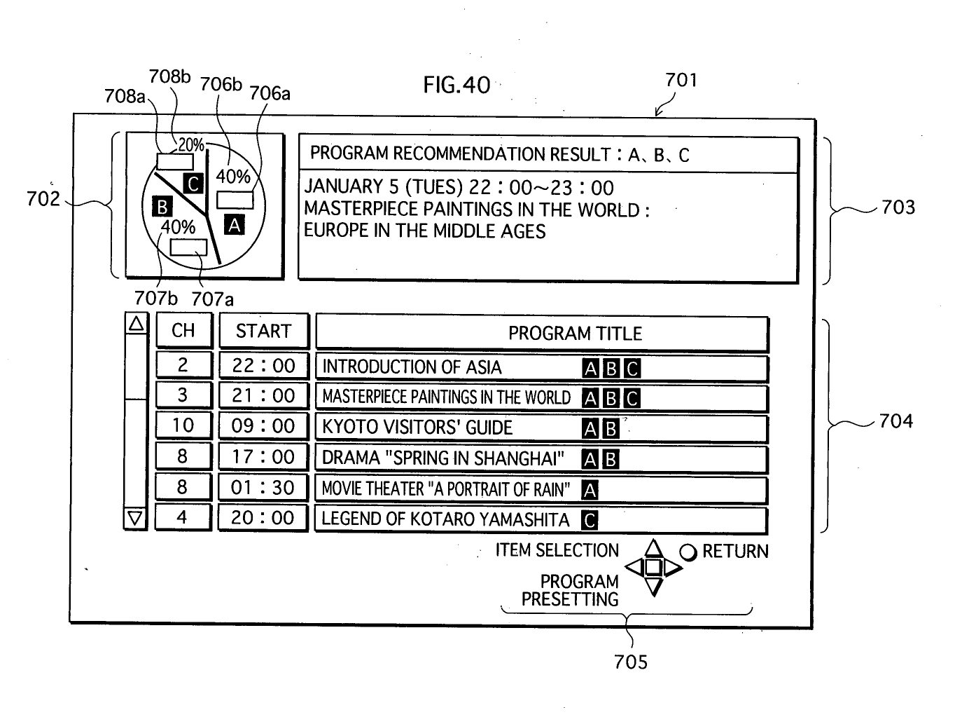

(22) The GUI generation unit 117 may generate a recorded program screen 701 shown in FIG. 40, and output the generated recorded program screen 701 to the output unit 110, so that the monitor 119 displays the recorded program screen 701.

In the recorded program screen 701, a priority input screen 702 and a program information section 703 are positioned in the upper part, and a recorded program table 704 and an operation button group 705 are positioned in the lower part.

The priority input screen 702 is the same as that described above. Here, the GUI generation unit 117 may obtain a favorite genre for each viewer, generate a reduced image of a representative screen (a still image) of a most recommended program for each viewer, generate a preview image (a moving image) of a representative program for each viewer, or obtain a value of the priority of each viewer. Thus, the sectors of the priority input screen 702 respectively corresponding to the viewers may additionally display favorite genres of the viewers, or reduced images (thumbnails) 706a, 707a, and 708a of representative screens (still images) of most recommended programs for the viewers. The thumbnails 706a, 707a, and 708a may be preview images (moving images) of representative programs. Furthermore, the sectors may display the values 706b, 707b, and 708b of the priorities directly or in percentage (%).

Whether such information is displayed or not may be determined in accordance with the central angle of each of the sectors. In detail, it is first judged whether each sector has a sufficient size to display such information. If judged in affirmative, each sector displays such information. If judged in negative, each sector may not display such information. As an alternative example, each sector may not display such information when having the central angle of less than 30 degrees, and displays such information when having the central angle of 30 or more degrees.

The program information section 703 includes information about a recommended program.

The recorded program table 704 displays programs in the order of recommendation as described above. In detail, the recorded program table 704 displays information of each program such as a broadcast channel, a broadcast starting time (in hours and minutes), and a program title. For each program, the recorded program table 704 further displays an icon of a viewer who likes the program.

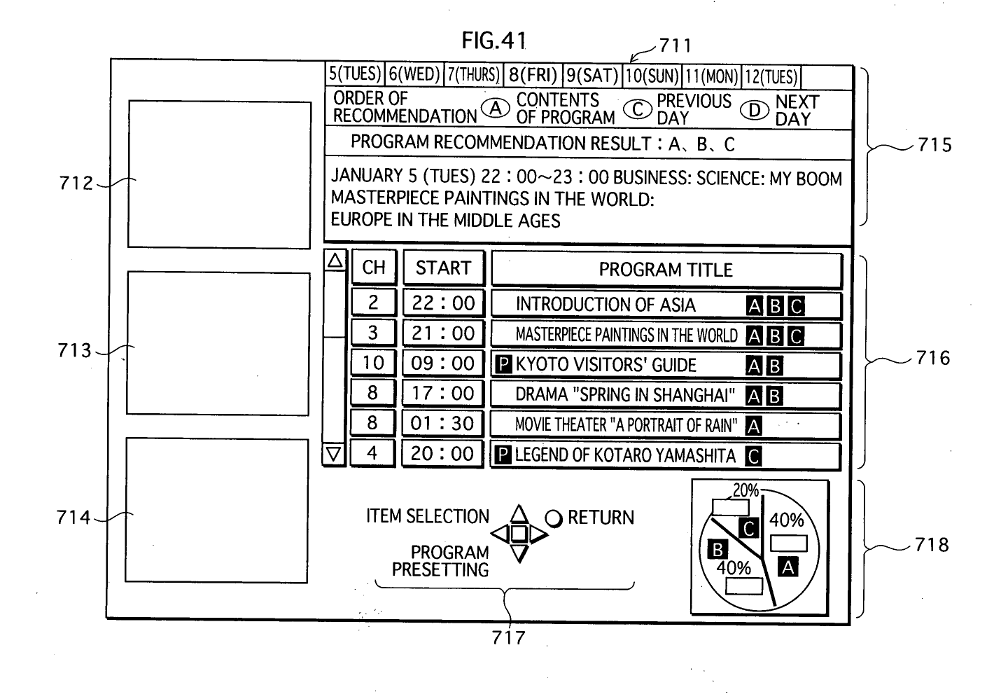

(23) The GUI generation unit 117 may generate a recorded program screen 711 shown in FIG. 41, and output the generated recorded program screen 711 to the output unit 110, so that the monitor 119 displays the recorded program screen 711.

In the recorded program screen 711, display areas 712, 713 and 714 are arranged on the left side, and a program information section 715, a recorded program table 716, an operation button group 717, and a priority input screen 718 are arranged in this order from top on the right side.

The display area 712 displays a program, and the display areas 713 and 714 display advertisement.

As mentioned above, the sectors of the priority input screen 718 respectively corresponding to the viewers may additionally display favorite genres of the viewers, reduced images of representative screens of recommended programs for the viewers, or values of the priorities. Whether such information is displayed or not may be determined by the central angle of each sector.

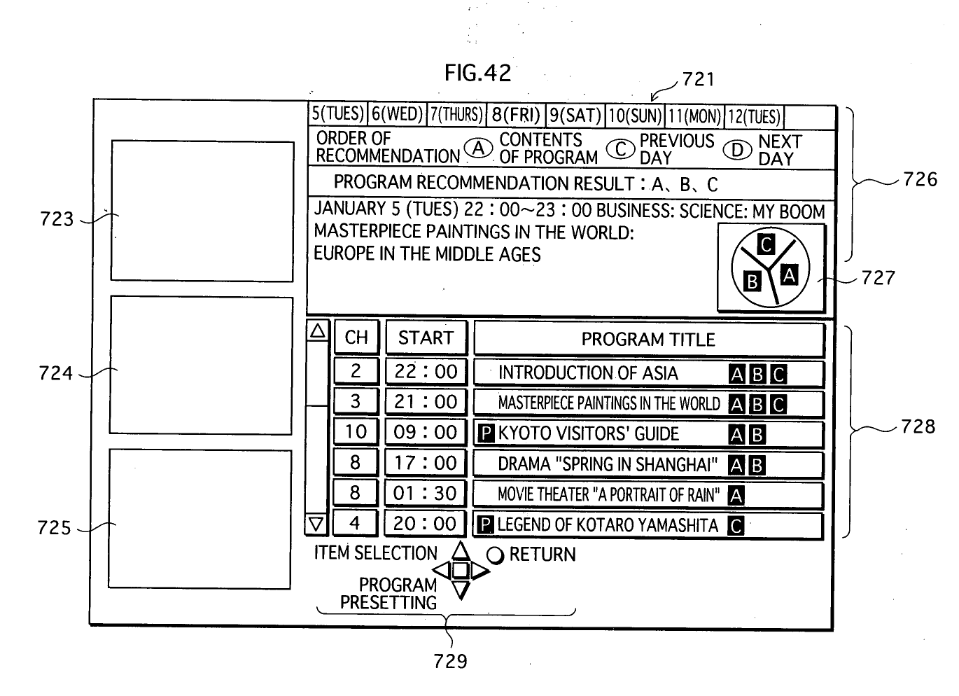

(24) The GUI generation unit 117 may generate a recorded program screen 721 shown in FIG. 42, and output the generated recorded program screen 721 to the output unit 110, so that the monitor 119 displays the recorded program screen 721.

In the recorded program screen 721, display areas 723, 724 and 725 are arranged on the left side, and a program information section 726, a priority input screen 727, a recorded program table 728, and an operation-button group 729 are arranged in this order from top on the right side.

The display area 723 displays a program, and the display areas 724 and 725 display advertisement.

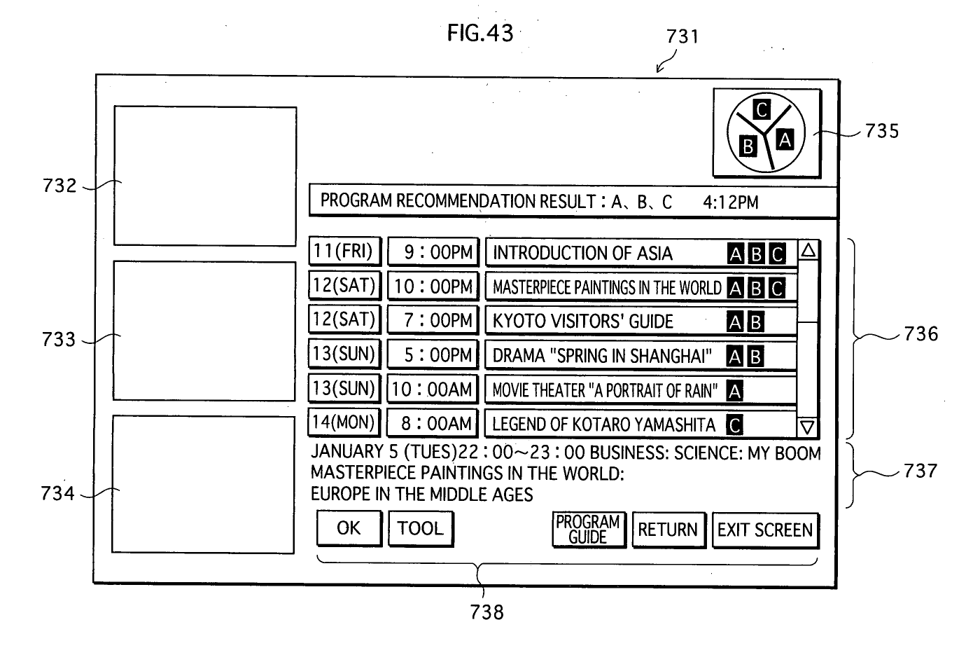

(25) The GUI generation unit 117 may generate a recorded program screen 731 shown in FIG. 43, and output the generated recorded program screen 731 to the output unit 110, so that the monitor 119 displays the recorded program screen 731.

In the recorded program screen 731, display areas 732, 733 and 734 are arranged on the left side, and a priority input screen 735, a recorded program table 736, a program information section 737, and an operation button group 738 are arranged in this order from top on the right side.

The display area 732 displays a program, and the display areas 733 and 734 display advertisement.

(26) The recording/playback apparatus 100 and monitor 119 may constitute one integrated apparatus.

(27) Each apparatus described above is specifically a computer system constituted by a microprocessor, a ROM, a RAM, a hard disc unit, a display unit, a keyboard, a mouse and the like. The RAM or hard disc unit records thereon a computer program. The microprocessor operates in accordance with the computer program, which realizes the functions of each apparatus.

(28) The present invention may be realized by the methods described above. The present invention may be realized by a computer program that is executed on a computer to attain these methods. Furthermore, the present invention may be realized by a digital signal indicating the computer program.

The present invention may be realized by a computer-readable recording medium on which the computer program or digital signal is recorded. The recording medium includes a flexible disc, a hard disc, a CD-ROM, an MO, a DVD, a DVD-ROM, a DVD-RAM, a Blu-ray disc (BD) and a semiconductor memory. Alternatively, the present invention may be realized by the computer program or digital signal recorded on such a recording medium.

The present invention may be realized by the computer program or digital signal which is transmitted via a network such as an electronic communication network, a wireless or wired communications network, and the Internet or via data broadcasting.

The present invention can be also realized by a computer system including a microprocessor and a memory storing thereon the computer program. The microprocessor operates in accordance with the computer program.

The computer program or digital signal may be provided to an independent computer system, by distributing the above-mentioned recording medium recording thereon the computer program or digital signal, or by transferring the computer program or digital signal through the above-mentioned network. In this way, the independent computer system can execute the computer program or digital signal.

(29) The embodiment and modification examples may be freely combined.

### 3. SUMMARY

As described above, the present invention provides a program presetting information generation apparatus characterized by comprising a program recommendation information input unit, a program recommendation information storage unit, a search information generation unit, and a presetting information extraction unit. The program recommendation information input unit receives a plurality of pieces of program recommendation information each generated by a user or group of users. The program recommendation information storage unit stores the plurality of pieces of program recommendation information input to the program recommendation information input unit. The search information generation unit generates program search information used to search for a program, by performing a combination operation on a plurality of pieces of program recommendation information selected from the plurality of pieces of program recommendation information stored in the program recommendation information storage unit. The presetting information extraction unit extracts presetting information for recording or playing back a program obtained as a result of the search based on the program search information.

According to this construction, multiple pieces of program recommendation information generated by users or groups of users can be input, from an external source, into the program presetting information generation apparatus. The program presetting information generation apparatus can then generate program search information by performing a combination operation on the input pieces of program recommendation information. Thus, the present apparatus can meet various needs of viewers who watch a program together, such needs including a request for program recommendation information indicating a common preference between program recommendation information of one viewer and program recommendation information of a different viewer.

Here, each of the plurality of pieces of program recommendation information may be configured to include information identifying a user or group of users who has generated the program recommendation information.

According to this construction, program recommendation information includes information identifying a user or group of users who has generated the program recommendation information. Thus, when given program recommendation information by a different viewer, for example, a viewer can determine whether to use the program recommendation information based on a name, credibility, a social status or the like of a viewer or group of viewers who has generated the program recommendation information.

Here, each of the plurality of pieces of program recommendation information may be configured to include at least one of keyword information that is used when a program is searched for, search formula information including keyword information, and information specifying broadcast time and channel of a program.

According to this construction, a desired program can be easily selected. Also, a user or group of users can write keyword information or search formula information into program recommendation information.

Here, the plurality of pieces of program recommendation information may be input into the program recommendation information input unit by a different apparatus via a digital network.

According to this construction, program recommendation information generated by a different viewer can be input into the program presetting information generation apparatus, via a digital network. The program presetting information generation apparatus can perform a combination operation based on this program recommendation information.

The program presetting information generation apparatus may further comprise a program recommendation information output unit that outputs the plurality of pieces of program recommendation information stored in the program recommendation information storage unit.

According to this construction, the program presetting information generation apparatus can output program recommendation information stored thereon to a different apparatus, for example. Thus, a viewer can watch or record a program matching his/her own preference, at an apparatus different from an apparatus the viewer normally uses, based on program recommendation information the viewer normally uses. Furthermore, a viewer can transmit his/her own program recommendation information to a different viewer.

Here, the plurality of pieces of program recommendation information may be output from the program recommendation information output unit to a different apparatus via a digital network.

According to this construction, the program presetting information generation apparatus can transmit program recommendation information, which is obtained as a result of a combination operation, to a server, a different viewer's apparatus, or the like, via a digital network.

The program presetting information generation apparatus may further comprise an EPG information storage unit that stores EPG information about programs. Here, the presetting information extraction unit may be configured to extract presetting information from the EPG information stored in the EPG information storage unit.

According to this construction, the program presetting information generation apparatus can extract a program matching a viewer's preference, from EPG information obtained through broadcasting or the like.

Here, the presetting information extraction unit may be configured to output an abnormal signal when the presetting information indicates programs whose broadcasting time periods overlap each other.

According to this construction, the program presetting information generation apparatus can realize a configuration suitable for a recording apparatus or the like which is mounted with only one tuner.

Here, the search information generation unit may be configured to include an operation unit that performs a combination operation including a logical operation selected from a logical OR operation, a logical AND operation, a logical EXCLUSIVE OR operation, a logical NOT operation, a logical NAND operation, and a logical NOR operation.

According to this construction, the operation unit can easily perform a combination operation.

Here, the operation unit may be configured to perform a combination operation equivalent to a combination of two or more of a logical OR operation, a logical AND operation, a logical EXCLUSIVE OR operation, a logical NOT operation, a logical NAND operation, and a logical NOR operation.

According to this construction, the program presetting information generation apparatus can extract a program matching a user's preference that is further meticulously defined.

Here, each of the plurality of pieces of program recommendation information input into the program recommendation information input unit may be text information written in XML.

According to this construction, a viewer or the like can easily write program recommendation information using a publicly-known editor or the like. By using program recommendation information written in such a widely-known language, the program presetting information generation apparatus can easily interpret the program recommendation information, and perform a combination operation based on the program recommendation information, for example.

Here, the search information generation unit may be configured to include an interpretation unit that interprets text information.

According to this construction, program recommendation information, which is text information, can be converted so as to be easily processed by an application forming the operation unit or the like.

Here, the program presetting information generation apparatus may further comprise an input unit that receives information about the combination operation performed by the search information generation unit. The search information generation unit may perform a combination operation based on the information input into the input unit.

According to this construction, a viewer and the like can input a desired operation into the input unit. Thus, the program presetting information generation apparatus can generate program presetting information satisfying the viewer's need.

Here, each of the plurality of pieces of program recommendation information may be configured to include viewing permission information which indicates whether a user or group of users is permitted to watch a program or channel obtained as a result of the search. A recording/playback apparatus extracts viewing permission information from program recommendation information obtained from without or read from within, and judges whether viewing is permitted or not based on the extracted viewing permission information. When viewing is not permitted, the program presetting information generation apparatus does not use this program recommendation information when searching through program information. When viewing is permitted, the program presetting information generation apparatus uses this program recommendation information when searching through program information.

According to this construction, the program presetting information generation apparatus can search through EPG data based on the program search information generated by the search information generation unit, excluding a program or channel viewing of which is not permitted. Thus, the program presetting information generation apparatus can efficiently search through the EPG data in order to generate the program presetting information.

Here, each of the plurality of pieces of program recommendation information may be configured to include comment information generated by a user or group of users.

According to this construction, program recommendation information can include comment information generated by a user or group of users regarding the program recommendation information itself or the program indicated by the program recommendation information. Thus, when given program recommendation information, for example, a viewer can obtain a different viewer's opinion about the program recommendation information.

The present invention also provides a recording apparatus characterized by comprising the above-described program presetting information generation apparatus, a program reception unit, and a recording program selection unit. The program reception unit receivers a plurality of programs, and the recording program selection unit selects a program to be recorded, from the programs received by the program reception unit, according to presetting information.

According to this construction, the recording apparatus can select and record a program according to a variety of preferences defined so as to reflect both a program preference stored thereon and a program preference input by a different apparatus, defined by a combination of a plurality of pieces of program recommendation information, and the like.

The present invention also provides a playback apparatus characterized by comprising the above-described program presetting information generation apparatus, a storage unit, and a playing program selection unit. The storage unit stores information indicating a plurality of programs, and the playing program selection unit selects a program to be played back, from the programs stored in the storage unit, according to presetting information.

According to this construction, the playback apparatus can select a program, from content information indicating audio information, visual information, and the like stored in the storage unit, according to a variety of preferences defined so as to reflect both a program preference stored thereon and a program preference input by a different apparatus, defined by a combination of a plurality of pieces of program recommendation information, and the like, and play back the selected program.

Here the playback apparatus may further comprise a playback unit that aligns the programs selected by the playing program selection unit in chronological order, and broadcasts the selected programs continuously.

According to this construction, by selecting predetermined program recommendation information in advance, a viewer can continuously watch programs all of which match his/her preference, which are selected from the content information stored in the storage unit, without the need of presetting each program.

The present invention also provides a recording/playback apparatus characterized by comprising the above-described program presetting information generation apparatus, a program reception unit, a recording program selection unit, a storage unit, and a playing program selection unit. The program reception unit receivers a plurality of programs. The recording program selection unit selects a program to be recorded, from the programs received by the program reception unit, according to first presetting information generated by the program presetting information generation apparatus. The storage unit stores information indicating the programs selected by the recording program selection unit. The playing program selection unit selects a program to be played back, from the information stored in the storage unit, according to second presetting information generated by the program presetting information generation apparatus.

According to this construction, the recording/playback apparatus can select a program according to a variety of preferences defined so as to reflect both a program preference stored thereon and a program preference input by a different apparatus, defined by a combination of a plurality of pieces of program recommendation information, and the like, and record the selected program in the storage unit. Furthermore, the recording/playback apparatus can select a program, from content information indicating audio information, visual information, and the like stored in the storage unit, according to a variety of preferences defined so as to reflect both a program preference stored thereon and a program preference input by a different apparatus, defined by a combination of a plurality of pieces of program recommendation information, and the like, and play back the selected program.

The present invention also provides a program presetting information generation method characterized by comprising first, second, third, and fourth steps. In the first step, a plurality of pieces of program recommendation information that can be combined are input into a search information generation unit via a program recommendation information input unit. In the second step, the search information generation unit interprets the plurality of pieces of program recommendation information input by the program recommendation information input unit, to generate a plurality of pieces of search information, and outputs the generated plurality of pieces of search information to an operation unit. In the third step, the operation unit performs a combination operation on the plurality of pieces of search information, to generate program search information, and outputs the generated program search information to a presetting information extraction unit. In the fourth step, the presetting information extraction unit extracts program presetting information from EPG information stored in an EPG information storage unit, based on the program search information.

According to this method, a plurality of pieces of program recommendation information that can be combined are input from an external source. Thus, program recommendation information generated by a different apparatus is input, program search information is generated by a combination operation performed on the input program recommendation information, and program presetting information is extracted from EPG information, based on the program search information. In this way, the present method can meet various needs of viewers who record or play back a program together, such needs including a request for program recommendation information indicating a common preference between program recommendation information of one viewer and program recommendation information of a different viewer.

The present invention also provides a computer program characterized by causing a computer to execute first, second, and third steps. In the first step, a plurality of pieces of program recommendation information that can be combined are input into the computer. In the second step, the computer interprets the plurality of pieces of program recommendation information, to generate a plurality of pieces of search information. In the third step, the computer performs a combination operation on the plurality of pieces of search information, to generate program search information.

According to this computer program, a plurality of pieces of program recommendation information that can be combined are input into the computer. Thus, program recommendation information generated by a different apparatus is input, and program search information is generated by a combination operation performed on the input program recommendation information. In this way, the present computer program can meet various needs of viewers who record or play back a program together, such needs including a request for program recommendation information indicating a common preference between program recommendation information of one viewer and program recommendation information of a different viewer.

The present invention also provides a program recommendation apparatus that extracts program information relating to a recommended program. The program recommendation apparatus is characterized by comprising an information storage unit, an information obtaining unit, an information extraction unit, a program guide generation unit, and a program guide output unit. The information storage unit stores, in association with each of a plurality of users, user recommendation information relating to a program recommended to the user. The information obtaining unit obtains program information relating to programs to be broadcast. The information extraction unit extracts user program information, for each of the users, from the obtained program information, based on user recommendation information corresponding to the user. Here, the user program information indicates a program recommended to the user. The program guide generation unit generates a program guide showing a correspondence between the extracted user program information and the user. The program guide output unit outputs the generated program guide to be displayed.

The present invention also provides a program recommendation apparatus that extracts program information relating to a recommended program. The program recommendation apparatus is characterized by comprising a program information obtaining unit, a first obtaining unit, a second obtaining unit, a generation unit, and an extraction unit. The program information obtaining unit obtains program information relating to programs to be broadcast. The first obtaining unit obtains first recommendation information relating to a recommended program. The second obtaining unit obtains second recommendation information relating to a different recommended program. The generation unit generates program search information indicating a program search condition, based on the obtained first recommendation information and second recommendation information. The extraction unit extracts program information satisfying the program search condition indicated by the program search information, from the obtained program information.

The present invention also provides a program recommendation apparatus that extracts program information relating to a recommended program. The program recommendation apparatus is characterized by comprising a program information obtaining unit, a first obtaining unit, a second obtaining unit, a generation unit, and an extraction unit. The program information obtaining unit obtains program information relating to programs to be broadcast. The first obtaining unit obtains first recommendation information indicating a first program search condition. The second obtaining unit obtains second recommendation information indicating a second program search condition. The generation unit generates program search information indicating a recommendation condition identifying a recommended program, based on the first and second program search conditions respectively indicated by the obtained first recommendation information and second recommendation information. The extraction unit extracts program information satisfying the recommendation condition indicated by the generated program search information, from the obtained program information.

According to the program presetting information generation apparatus, recording apparatus, playback apparatus, and recording/playback apparatus utilizing the program presetting information generation apparatus, program presetting information generation method, and computer program, program recommendation information generated by a different apparatus is input, and a combination operation can be performed based on the input program recommendation information. Thus, the present invention can meet various needs of viewers who record or play back a program together, such needs including a request for program recommendation information indicating a common preference between program recommendation information of one viewer and program recommendation information of a different viewer.

According to the program presetting information generation apparatus, recording apparatus, playback apparatus, and recording/playback apparatus utilizing the program presetting information generation apparatus, program presetting information generation method, and computer program, program recommendation information generated by a different apparatus is input, and a combination operation can be performed based on the input program recommendation information. Thus, the present invention can produce effects of meeting various needs of viewers who watch a program together, such needs including a request for program recommendation information indicating a common preference between program recommendation information of one viewer and program recommendation information of a different viewer. As a result, the present invention can be utilized to realize, for example, a program presetting information generation apparatus for generating program presetting information, a recording apparatus, a playback apparatus, and a recording/playback apparatus utilizing the program presetting information generation apparatus, a program presetting information generation method for generating program presetting information, and a computer program for generating program presetting information.

### INDUSTRIAL APPLICABILITY

The present invention can provide apparatuses that can be manufactured and sold by the electrical product manufacturing industry continuously, and recurrently, under administration of organizations.

1. A program recommendation apparatus for generating a program guide that includes recommended program information, comprising:
a program information obtaining unit operable to obtain a plurality of pieces of program information each relating to a program to be broadcast;
a first obtaining unit operable to obtain first recommendation information relating to a recommended program;
a second obtaining unit operable to obtain second recommendation information relating to a different recommended program;
a recommendation information generating unit operable to generate, for a user, user recommendation information relating to a program recommended to the user, based on the obtained first recommendation information and second recommendation information;
a program guide generating unit operable to extract one or more pieces of recommended program information each relating to a program recommended to the user, from the obtained plurality of pieces of program information, with reference to the generated user recommendation information, and generate a program guide including the extracted pieces of recommended program information in association with the user; and
an output unit operable to output the generated program guide to be displayed.

2. The program recommendation apparatus of claim 1, wherein
the program guide generating unit aligns the extracted pieces of recommended program information in an order determined according to a priority assigned to the user, and generates the program guide including the aligned extracted pieces of recommended program information.

3. The program recommendation apparatus of claim 2, further comprising:
a screen generating unit operable to form a plurality of user display areas respectively having sizes determined according to priorities assigned to a plurality of users including the user, and generate a priority screen including the formed plurality of user display areas; and
a screen output unit operable to output the generated priority screen to be displayed.

4. The program recommendation apparatus of claim 3, wherein
the screen generating unit generates the priority screen which is circular, forms the plurality of user display areas which are respectively sectors, and arranges the sectoral user display areas around a central point of the circular priority screen.

5. The program recommendation apparatus of claim 3, wherein
the screen generating unit forms the plurality of user display areas which are rectangular, and arranges the rectangular user display areas within the priority screen.

6. The program recommendation apparatus of claim 3, wherein
the screen generating unit further causes a plurality of pieces of priority information respectively indicating the priorities assigned to the plurality of users, to be displayed in the plurality of user display areas.

7. The program recommendation apparatus of claim 3, wherein
the screen generating unit further obtains genre information indicating a program genre corresponding to the user recommendation information, and causes the obtained genre information to be displayed within a corresponding one of the plurality of user display areas.

8. The program recommendation apparatus of claim 3, wherein
the screen generating unit further obtains a representative image of the program recommended by the user recommendation information, and causes the obtained representative image to be displayed within a corresponding one of the plurality of user display areas.

9. The program recommendation apparatus of claim 3, further comprising:
a receiving unit operable to receive an increase or decrease in the sizes of the plurality of user display areas included in the priority screen; and
a modifying unit operable to modify the priorities assigned to the plurality of users, based on the sizes of the plurality of user display areas which have been changed according to the received increase or decrease.

10. The program recommendation apparatus of claim 1, wherein
the program guide generating unit aligns the extracted pieces of recommended program information in a chronological order, and generates the program guide including the chronologically aligned extracted pieces of recommended program information.

11. The program recommendation apparatus of claim 1, wherein
the program information obtaining unit obtains the plurality of pieces of program information, by receiving a broadcast wave carrying the plurality of pieces of program information and extracting the plurality of pieces of program information from the received broadcast wave.

12. The program recommendation apparatus of claim 11, wherein
the program information obtaining unit obtains the plurality of pieces of program information each of which at least includes a summary of the program, a scheduled broadcast time of the program, a duration of the program, and a broadcast channel of the program, and
the program guide generating unit extracts the pieces of recommended program information, with reference to the summary of the program included in each of the plurality of pieces of program information.

13. The program recommendation apparatus of claim 1, wherein
the first obtaining unit obtains the first recommendation information from a different apparatus, and
the second obtaining unit includes:
a recommendation information storing unit prestoring the second recommendation information; and
a recommendation information reading unit operable to read the second recommendation information from the recommendation information storing unit.

14. The program recommendation apparatus of claim 13, wherein
the program recommendation apparatus is connected to the different apparatus via a network, and
the first obtaining unit obtains the first recommendation information from the different apparatus via the network.

15. The program recommendation apparatus of claim 13, wherein
the first obtaining unit obtains the first recommendation information including a first condition to select the recommended program,
the second obtaining unit obtains the second recommendation information including a second condition to select the different recommended program, and
the recommendation information generating unit extracts the first condition and second condition respectively from the first recommendation information and second recommendation information, combines the extracted first condition and the second condition using a logical operation, to generate a recommendation condition, and generates the user recommendation information including the generated recommendation condition.

16. The program recommendation apparatus of claim 15, wherein
the first obtaining unit obtains the first recommendation information including first keyword information as the first condition,
the second obtaining unit obtains the second recommendation information including second keyword information as the second condition,
the recommendation information generating unit extracts the first keyword information and second keyword information respectively from the first recommendation information and second recommendation information, and combines, using a logical operation, the extracted first keyword information and second keyword information, to generate the recommendation condition, and
the program guide generating unit extracts the pieces of recommended program information satisfying the recommendation condition included in the user recommendation information.

17. The program recommendation apparatus of claim 15, wherein
the first obtaining unit obtains the first recommendation information including a first search formula generated by combining a plurality of keywords using a logical operation, as the first condition,
the second obtaining unit obtains the second recommendation information including a second search formula generated by combining a plurality of keywords using a logical operation, as the second condition,
the recommendation information generating unit extracts the first search formula and second search formula respectively from the first recommendation information and second recommendation information, and combines, using a logical operation, the extracted first search formula and second search formula, to generate the recommendation condition, and
the program guide generating unit extracts the pieces of recommended program information satisfying the recommendation condition included in the user recommendation information.

18. The program recommendation apparatus of claim 15, wherein
the recommendation information generating unit receives a designation of a logical operation from the user, and combines the first condition and second condition using the received logical operation.

19. The program recommendation apparatus of claim 1, wherein
the first obtaining unit obtains the first recommendation information including viewing permission information indicating whether the user has viewing permission,
the recommendation information generating unit generates the user recommendation information including the viewing permission information, and
the program guide generating unit extracts the viewing permission information from the user recommendation information, and when the extracted viewing permission information indicates that the user has viewing permission, extracts the pieces of recommended program information.

20. The program recommendation apparatus of claim 1, wherein
the first obtaining unit obtains the first recommendation information including generator identification information indicating a generator who has generated the first recommendation information.

21. The program recommendation apparatus of claim 1, further comprising:
a recommendation information generation unit operable to generate output recommendation information, based on the user recommendation information generated by the recommendation information generating unit; and
an external output unit operable to output the generated output recommendation information to an external apparatus.

22. The program recommendation apparatus of claim 21, wherein
the program recommendation apparatus is connected to the external apparatus via a network, and
the external output unit outputs the output recommendation information to the external apparatus via the network.

23. The program recommendation apparatus of claim 1, which is a reception/recording apparatus for receiving and recording a broadcast,
the program recommendation apparatus further comprising:
a receiving unit operable to receive a broadcast program content;
an information storing unit;
a judging unit operable to judge whether the received program content is to be recorded, with reference to the user recommendation information generated by the recommendation information generating unit; and
a writing unit operable to write, when the judging unit judges that the program content is to be recorded, the program content into the information storing unit.

24. The program recommendation apparatus of claim 23, wherein the program guide output by the output unit is displayed by a display apparatus, and
the program recommendation apparatus further comprises:
a reception unit operable to receive a selection of one of programs included in the program guide displayed by the display apparatus;
a reading unit operable to read a program content corresponding to the selected program, from the information storing unit;
a signal generating unit operable to generate an audio-visual signal from the read program content; and
a signal output unit operable to output the generated audio-visual signal to the display apparatus.

25. A program recommendation method used in a program recommendation apparatus for generating a program guide including recommended program information, the program recommendation method comprising:
a program information obtaining step of obtaining a plurality of pieces of program information each relating to a program to be broadcast;
a first obtaining step of obtaining first recommendation information relating to a recommended program;
a second obtaining step of obtaining second recommendation information relating to a different recommended program;
a recommendation information generating step of generating, for a user, user recommendation information relating to a program recommended to the user, based on the obtained first recommendation information and second recommendation information;
a program guide generating step of extracting one or more pieces of recommended program information each relating to a program recommended to the user, from the obtained plurality of pieces of program information, with reference to the generated user recommendation information, and generating a program guide including the extracted pieces of recommended program information in association with the user; and
an output step of outputting the generated program guide to be displayed.

26. A computer program to be used in a program recommendation apparatus for extracting program information relating to a recommended program, the computer program causing a computer to execute:
a program information obtaining step of obtaining a plurality of pieces of program information each relating to a program to be broadcast;
a first obtaining step of obtaining first recommendation information relating to a recommended program;
a second obtaining step of obtaining second recommendation information relating to a different recommended program;
a recommendation information generating step of generating, for a user, user recommendation information relating to a program recommended to the user, based on the obtained first recommendation information and second recommendation information;
a program guide generating step of extracting one or more pieces of recommended program information each relating to a program recommended to the user, from the obtained plurality of pieces of program information, with reference to the generated user recommendation information, and generating a program guide including the extracted pieces of recommended program information in association with the user; and
an output step of outputting the generated program guide to be displayed.

27. The computer program of claim 26 which is recorded on a computer-readable recording medium.
